(19) United States
(12) Patent Application Publication
(10) Pub. No.: US 2016/0349972 A1
(43) Pub. Date: Dec. 1, 2016

(54) DATA BROWSE APPARATUS, DATA BROWSE METHOD, AND STORAGE MEDIUM

(71) Applicant: CANON KABUSHIKI KAISHA, Tokyo (JP)

(72) Inventors: Kunihiko Miyoshi, Kawasaki-shi (JP); Hajime Futatsugi, Tokyo (JP)

(21) Appl. No.: 15/166,012

(22) Filed: May 26, 2016

(30) Foreign Application Priority Data
Jun. 1, 2015 (JP) 2015-111787

(51) Int. Cl. G06F 3/0484; G06T 11/20; G06T 3/20; G06F 3/0485; G06T 3/40; G06T 3/60; G06F 17/30; G06F 3/0488

(52) U.S. Cl. CPC G06F 3/04845; G06F 17/30604; G06T 11/203; G06T 11/206; G06F 3/04883; G06F 3/0485; G06T 3/40; G06T 3/60; G06T 3/20; G06F 2203/04808

(57) ABSTRACT

There is provided a data browse apparatus that can improve visibility by controlling a display content regarding data having a high degree of correlation with an instruction direction among pieces of data on a browse screen. The data browse apparatus includes a data direction acquisition unit configured to acquire a direction indicated by data expressing a path as a data direction, an instruction direction acquisition unit configured to acquire a direction in a space of the data as an instruction direction, a relationship acquisition unit configured to acquire a relationship between the data direction and the instruction direction, and a display control unit configured to perform display control so as to make a difference in display content among a plurality of pieces of the data based on the relationship.

### BACKGROUND OF THE INVENTION

Field of the Invention

The present invention relates to a data browse apparatus, a data browse method, and a storage medium for displaying browse data.

Description of the Related Art

In recent years, the advancement of sensor devices and positioning systems has allowed various kinds of spatial data, such as global positioning system (GPS) positioning data acquired by a smart-phone, a car navigation system, or the like, trajectory data (i.e., traffic line data) acquired from an image analysis, and measured data acquired by a three-dimensional (3D) scanner, to be displayed as browse data. On the other hand, sophisticated analysis methods, such as machine learning, have been proposed to acquire some pattern or knowledge from a large number of pieces of such browse data, but an observation and an analysis by a person still hold high importance at an initial stage of the analysis.

These circumstances lead to the current needs for an effective and efficient browse method for the large number of pieces of browse data. For example, a commonly used method regarding trajectory data acquired by a GPS or the like is to allow a user to browse the trajectory data with, for example, the trajectory data displayed so as to be superimposed on a map. More specifically, the user can reach a discovery of a new knowledge about a behavior pattern or the like by changing granularity of the display or a portion of interest to thereby browse the data from various perspectives.

Japanese Patent Application Laid-Open No. 08-219803 discusses a method that allows the user to efficiently browse the browse data. The technique discussed in Japanese Patent Application Laid-Open No. 08-219803 changes a detail level of a map that is being scrolled according to a speed of a scroll operation for moving a viewpoint when the user browses map data. More specifically, this technique limits displayed roads to only wide or main roads as the speed increases. Limiting the display in this manner improves visibility of the map that is being scrolled, and saves resources and a load used for drawing processing.

However, although the technique discussed in Japanese Patent Application Laid-Open No. 08-219803 provides an effect of efficiently acquiring an outline indicated by the data, this technique has a problem in that the screen scrolls while keeping reducing the detail level evenly regardless of a scroll direction. For example, once the user starts tracking displayed data, the user can no longer browse the data except for data displayed with a low detail level while scrolling the map. Therefore, the user has to stop scrolling the map to browse detailed data. Further, if important data is included in data skipped while the user scrolls the map, the user may overlook the important data.

On the other hand, browsing the data while maintaining the detail level results in an excessive information amount, thereby raising a possibility of a reduction in the visibility. For example, when the user traces a flow of a trajectory that the user pays attention to while scrolling the screen in a case where the user browses a large number of pieces of trajectory data, the screen may display an overwhelming change when passing through a portion where many trajectories intersect with one another in a complicated manner, thereby causing the user to lose track of the flow of the trajectory that the user has been tracing.

A similar problem arises not only when the apparatus displays the screen while receiving the scroll instruction but also when the apparatus displays the data within a single screen. It is difficult for the apparatus to control the display while differentiating data indicating a desired direction among the pieces of data excessive in information amount.

### SUMMARY OF THE INVENTION

The present invention is directed to a technique, even when there are a large number of pieces of browse data, allowing a user to desirably browse the browse data while keeping a detail level thereof and maintaining visibility at the same time.

According to an aspect of the present invention, a data browse apparatus includes a data direction acquisition unit configured to acquire a direction indicated by data expressing a path as a data direction, an instruction direction acquisition unit configured to acquire a direction in a space of the data as an instruction direction, a relationship acquisition unit configured to acquire a relationship between the data direction and the instruction direction, and a display control unit configured to perform display control so as to make a difference in display content among a plurality of pieces of the data based on the relationship.

Further features of the present invention will become apparent from the following description of exemplary embodiments with reference to the attached drawings.

### BRIEF DESCRIPTION OF THE DRAWINGS

FIG. 1A is a block diagram illustrating an example of a configuration of a data browse apparatus according to a first exemplary embodiment, and FIG. 1B is a block diagram illustrating an example of a configuration of a control unit according to the first exemplary embodiment.

FIG. 2 illustrates an overview of a monitoring system including the data browse apparatus according to the first exemplary embodiment.

FIG. 3 illustrates tables indicating an example of trajectory data according to the first exemplary embodiment.

FIG. 4A illustrates an example of visualization of the trajectory data, FIG. 4B illustrates an example of a monitoring floor plan, and FIG. 4C illustrates an example of a user interface of the data browse apparatus.

FIGS. 5A and 5B illustrate an example of an operation performed on the data browse apparatus.

FIGS. 6A, 6B, 6C, and 6D illustrate an example of acquisition of a degree of correlation between input vector data input from an operation input unit, and the trajectory data.

FIG. 7A is a flowchart illustrating an operation of the data browse apparatus, and FIG. 7B illustrates a temporal example of an operation instruction input into the data browse apparatus.

FIGS. 8A, 8B, 8C, 8D, 8E, and 8F illustrate that a plurality of operation instructions is input from the operation input unit.

FIG. 9 is a flowchart illustrating an operation of a data browse apparatus according to a second exemplary embodiment.

FIGS. 10A, 10B, 10C, and 10D illustrate that a movement speed of a display range of a display unit is changed according to the degree of correlation.

FIG. 11 is a flowchart illustrating an operation of a data browse apparatus according to a third exemplary embodiment.

FIG. 12 illustrates an overview of a monitoring system including a data browse apparatus according to a fourth exemplary embodiment.

FIGS. 13A, 13B, 13C, 13D, and 13E illustrate imaging by an unmanned airplane.

FIG. 14 is a flowchart illustrating an operation of the data browse apparatus according to the fourth exemplary embodiment.

FIGS. 15A and 15B illustrate an example of calculating the degree of correlation between an instruction direction recorded per predetermined time period and a data direction.

FIGS. 16A and 16B illustrate examples of weighting the degree of correlation according to the acquired data and instruction direction, respectively.

FIGS. 17A, 17B, 17C, and 17D illustrate an example of predicting the instruction direction by calculating the degree of correlation of data located outside the display range.

FIGS. 18A and 18B illustrate an example of solid fabrication data in 3D scanned data or the like.

FIGS. 19A, 19B, 19C, and 19D illustrate an example of acquiring the data direction based on a position of point data on a map.

### DESCRIPTION OF THE EMBODIMENTS

A data browse apparatus according to an exemplary embodiment of the present invention includes a storage unit, a data direction acquisition unit, an instruction direction acquisition unit, a degree-of-correlation acquisition unit, and a display change unit.

The storage unit stores at least one piece of data among point data, line data, and plane data. The point data refers to data indicating a point or a position, such as data shaped as a point, coordinate data (positional data), and a vertex. Further, the line data refers to data indicating a line, such as the trajectory data, a boundary line, a line graph, tree structured data, and a social map. Further, the plane data refers to data indicating a plane, such as a flat plane, a curved plane, and a plane forming a solid shape.

The data direction acquisition unit acquires at least one of a position direction of the point data, a line direction of the line data, and a normal direction of the plane data as a data direction.

The instruction direction acquisition unit acquires an arbitrary direction of the data in a space as an instruction direction. The instruction direction acquisition unit acquires the instruction direction based on at least one of a touch, a multi-touch, a click, a scroll, a drag, a rotation, an angle, an angular speed, and an orientation input from an input unit. Further, the instruction direction acquisition unit may acquire a direction of a movement of the data due to an enlargement or a reduction of a display on a display unit as the instruction direction. Further, the instruction direction acquisition unit may acquire the instruction direction based on a movement direction of an imaging unit.

For example, a direction in which a finger is moved on a touch panel is acquired as the instruction direction. Further, when a screen is enlarged by a pinch-out performed on the touch panel, a direction radiating from a center of the pinch-out is acquired as the instruction direction. Further, when an unmanned airplane moves with the imaging unit mounted thereon, a movement direction of the unmanned airplane may be acquired as the instruction direction.

The degree-of-correlation acquisition unit calculates a degree of correlation between the data direction and the instruction direction. The degree-of-correlation acquisition unit calculates the degree of correlation based on at least one of an angle between the data direction and the instruction direction, a distance between an acquisition position of the data and an acquisition position of the instruction direction, and an inner product of the data and the instruction direction. The degree-of-correlation acquisition unit may acquire a degree of correlation calculated by an external apparatus.

The display change unit performs display control of changing a display style regarding data having a predetermined degree of correlation. The display change unit highlights data having a degree of correlation that is a predetermined threshold value or higher, or a predetermined threshold value or lower, on the display unit. Further, the display change unit may display the data on the display unit in an order of the degree of correlation, starting from data having a highest degree of correlation. Further, the display change unit may change the display style regarding the data according to a statistical value of degrees of correlation. Examples of the statistical value of degrees of correlation include a sum, an average, a median value, a maximum value, a minimum value, a dispersion, a standard deviation, a frequency.

According to the data browse apparatus of the exemplary embodiment of the present invention, it is possible to improve the visibility by changing the display style and extracting the data regarding the data having a high degree of correlation with the instruction direction among the pieces of data on a browse screen. The data browse apparatus performs the display control so as to make a difference in display content among a plurality of pieces of data based on a relationship, such as the degree of correlation. As a result, even when there are a large number of pieces of browse data, the data browse apparatus allows the user to desirably browse the browse data while keeping the detail level thereof and maintaining the visibility at the same time.

In the following description, representative exemplary embodiments to which the present invention is applied will be described in detail with reference to the attached drawings.

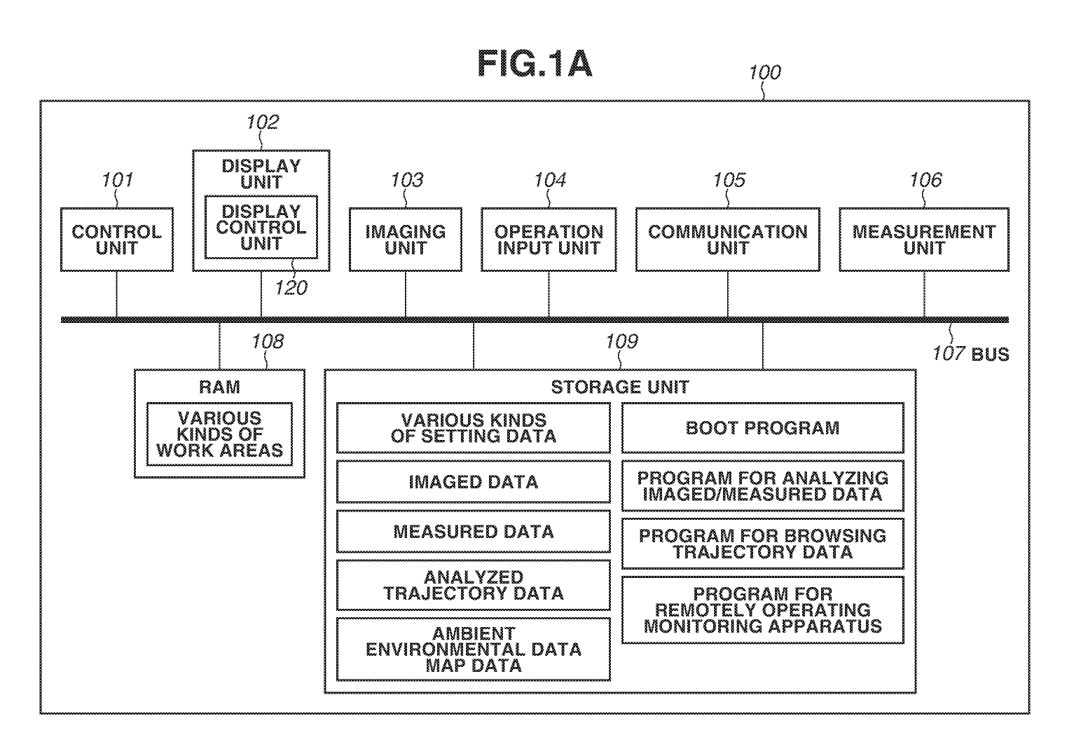

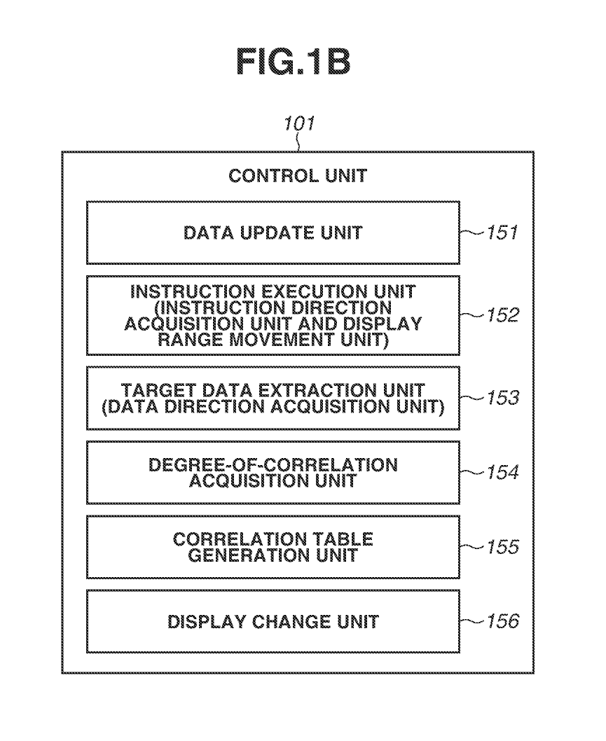

FIG. 1A illustrates an example of a configuration of a data browse apparatus 100 according to a first exemplary embodiment. FIG. 1B illustrates an example of a configuration of a control unit 101 according to the present exemplary embodiment. The control unit 101 includes a central processing unit (CPU), a micro processing unit (MPU), or the like, and for example, performs a calculation and a logical determination for information processing.

The control unit 101 includes a data update unit 151, an instruction execution unit (an instruction direction acquisition unit) 152, a target data extraction unit (a data direction acquisition unit) 153, a degree-of-correlation acquisition unit 154, a correlation table generation unit 155, and a display change unit 156. The control unit 101 controls each of components connected to a system bus 107 via the system bus 107. A display unit 102 includes a controller (a display control unit 120) that controls a display of image information, and an output apparatus, such as a liquid crystal panel and a projector.

An imaging unit 103 images a document and a person (including a behavior of the person). Types of the document include, for example, an electronic device display document that is displayed on a tablet device or the like, in addition to a document on a physical medium, such as a single sheet and a booklet. An operation input unit 104 is a button, a touch panel, a keyboard, a mouse, and/or the like, and inputs an instruction issued from a user by a touch, a multi-touch, a click, a scroll, and a drag.

A communication unit 105 is, for example, a network controller represented by the local area network (LAN) technique, the Third Generation (3G) technique, the Fourth Generation (4G) technique, the Bluetooth (registered trademark) technique, and the Radio Frequency Identification (RFID) technique, and is an external communication unit that controls a connection to another apparatus. The communication unit 105 may employ another communication method that can achieve a similar object.

A measurement unit 106 is a Global Positioning System (GPS) sensor, a gyro sensor, an electronic compass, and/or the like, and measures a position, a rotation, an angle, an angular speed, an orientation, and/or the like of the data browse apparatus 100. The measurement unit 106 serves as the input unit, similar to the operation input unit 104. A random access memory (RAM) 108 is used to temporarily store various kinds of data provided from each of the components. For example, the RAM 108 temporarily stores at least one of the point data, the line data, and the plane data.

A storage unit 109 stores various kinds of setting data, image data, and the like in addition to a control program code, such as a processing program to be executed in the present exemplary embodiment, with use of a physical medium, such as a flash memory, a hard disk drive (HDD), and an optical disk. For example, the storage unit 109 stores at least one of the point data, the line data, and the plane data.

The data browse apparatus 100, which includes each of the above-described components, is activated according to various kinds of inputs supplied from the operation input unit 104 or various kinds of inputs supplied from the communication unit 105 via a network. More specifically, upon the supply of the input from the operation input unit 104 or the input from the communication unit 105, an interrupt signal is transmitted to the control unit 101. Then, the control unit 101 reads out various kinds of control signals stored in the storage unit 109, and performs various kinds of control according to the control signals.

Further, the present exemplary embodiment may be realized by electrically connecting a storage medium storing a program according to the present exemplary embodiment to a system or an apparatus, and causing the system or the apparatus to read out a program code stored in the storage medium to then execute this program code.

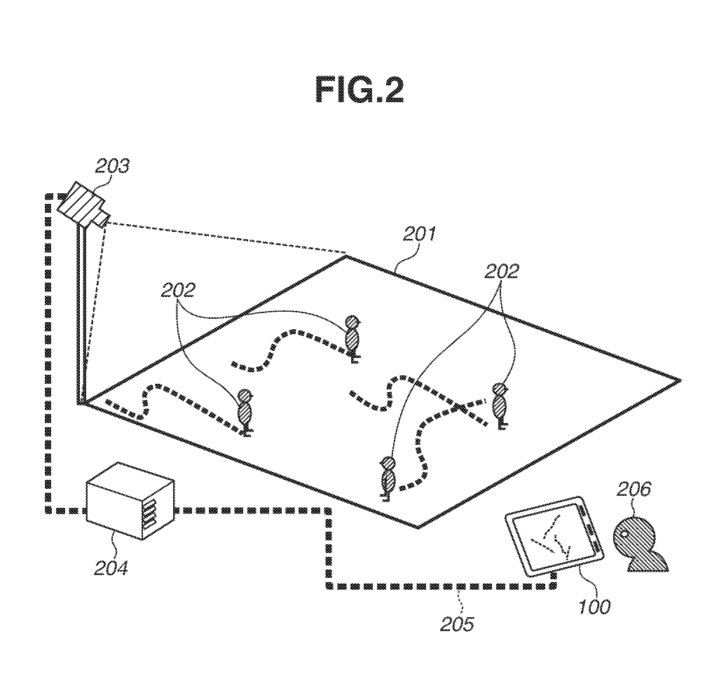

FIG. 2 illustrates an overview of a monitoring system including the data browse apparatus 100 according to the present exemplary embodiment. One or more pedestrian(s) is or are walking in a monitoring space 201. A monitoring camera apparatus (an imaging unit) 203 images the monitoring space 201. A monitoring server apparatus 204 connects the monitoring camera apparatus 203 and the data browse apparatus 100 to each other via a communication line 205.

An image captured by the monitoring camera apparatus 203 is transferred to the monitoring server apparatus 204, and accumulated and analyzed by the monitoring server apparatus 204. Trajectory data indicating a trail of a movement of a pedestrian 202 is acquired from a result of the analysis of the image as spatial data (browse data). The trajectory data is the line data. The data browse apparatus 100 outputs a display screen for browsing the accumulated data, in addition to controlling the monitoring server apparatus 204 and the entire monitoring system. Further, the data browse apparatus 100 receives an instruction issued from a surveillant 206, and aids the surveillant 206 to carry out a monitoring task.

Specific examples of the monitoring camera apparatus (the imaging unit) 203 include a camera capable of changing an angle of view and/or an orientation thereof, a camera mounted on a movable pan head, in addition to a fixed monitoring camera. A plurality of cameras may be set up as the monitoring camera apparatus 203 as necessary. Further, the monitoring camera apparatus 203 may analyze the image.

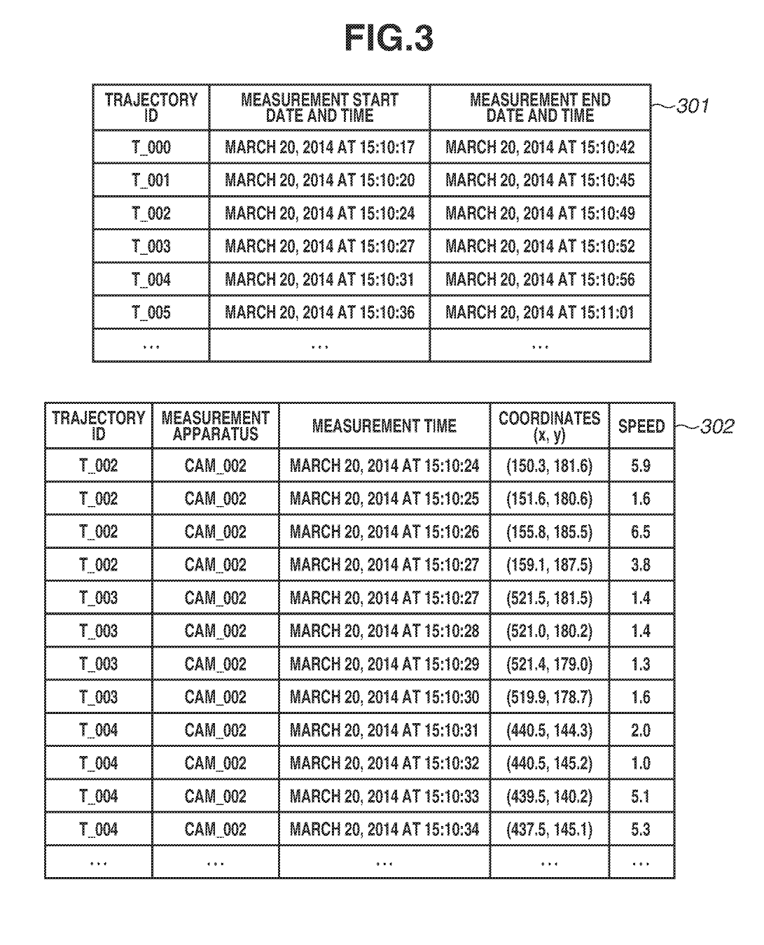

FIG. 3 illustrates an example of the trajectory data according to the present exemplary embodiment. As illustrated in FIG. 3, a trajectory identification (ID), a date and time when the measurement is started, and an end date and time when the measurement is ended corresponding to a trail (a trajectory) having a predetermined length are registered in a trajectory table 301. Further, an apparatus that measures the trajectory, a time when the trajectory is measured, coordinates, a speed, a direction, and the like are registered in a trajectory coordinate table 302 with respect to the trajectory ID defined in the trajectory table 301. The coordinates and the speed are managed by integrating measurement results output by a plurality of imaging units, and therefore are acquired as data in which the coordinates are converted into coordinates in a bird's eye floor plan with use of information acquired in advance regarding an imaging condition, such as a position and an angle of view of the imaging.

Methods employable to acquire the trajectory data include detection of a moving object using an inter-frame difference in a moving image, a transition of coordinates at which a face is detected, a path of a movement that is acquired from the GPS or a wireless tag. After a series of values such as a series of coordinates indicating the trajectory data is acquired along a time as an axis thereof with respect to the trajectory coordinate table 302, processing that will be described below is performed.

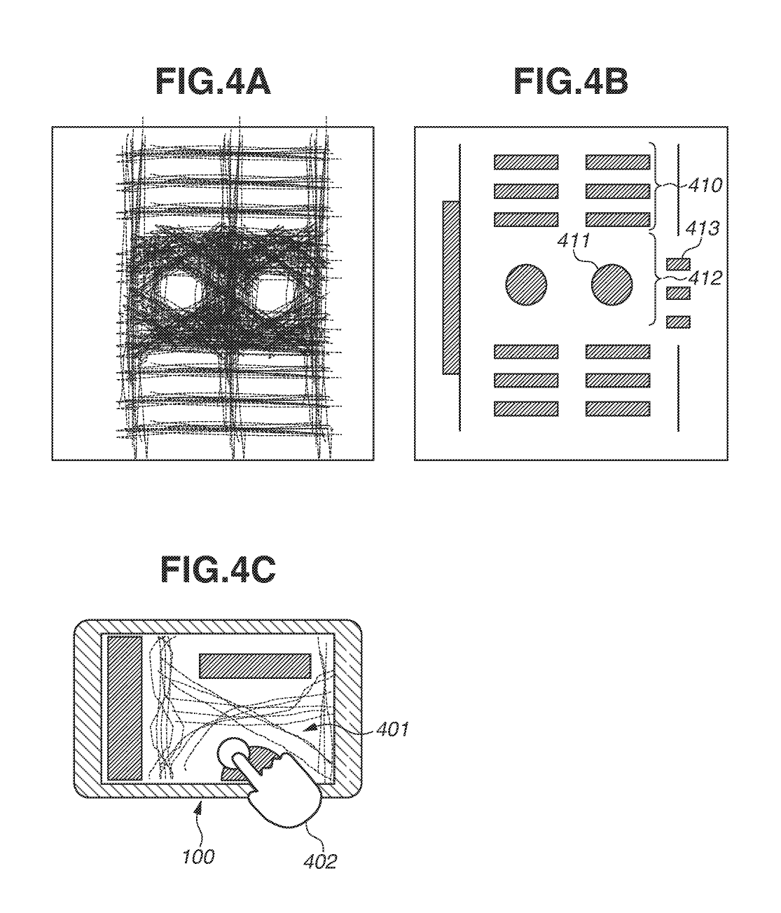

FIG. 4A illustrates an example of visualization of the trajectory data. The visualized trajectory data is displayed as a continuous line created by connecting the individual coordinates to one another via a straight line based on a group of coordinates belonging to each trajectory that is acquired from the trajectory table 301 and the trajectory coordinate table 302. Generally, the observed trajectory data is drawn as a predetermined pattern due to a layout of shelves, a shape of an aisle, and the like. In FIG. 4A, all coordinates of all trajectories are visualized, but the trajectory data to be visualized may be specified based on a specific date and time and/or a specific region as necessary.

FIG. 4B illustrates an example of a monitoring floor plan. FIG. 4B illustrates a floor plan of a store of a supermarket from which the trajectory data illustrated in FIG. 4A is acquired, in which grid-like aisles 410 are formed by the layout of the store shelves, and aisles 412 exist at a center of the floor plan with two columnar store shelves 411 placed among them. There is no wall and obstacle at upper and lower ends of the floor plan, and passage and entry/exit of a person are observed if these actions happen in the monitoring space 209, but are not observed if these actions happen outside the monitoring space 209.

Further, cash registers 413 are placed on a right side of the floor plan, and exit of a person from a selling space is observed. It is also possible to expand the monitoring space 209 by, for example, setting up monitoring cameras in a wide region. Further, it is also possible to manage pieces of data indicating a same pedestrian 202 in association with one another by inputting and outputting entry/exit information and the like from and to another monitoring system.

FIG. 4C illustrates an example of a user interface of the data browse apparatus 100. A browse screen 401 (the display unit 102) displays at least one of the floor plans illustrated in FIGS. 4A and 4B. Further, an enlargement, a reduction, a movement of a viewpoint, and the like are carried out according to an instruction issued from a surveillant's hand 402 via the touch panel (the operation input unit 104). The surveillant 206 understands a behavior pattern of the pedestrian 202 by observing and analyzing the trajectory data observed with use of this user interface.

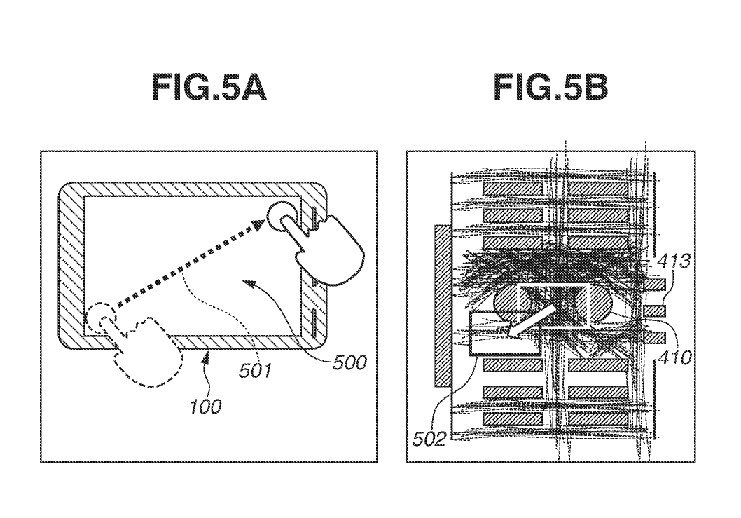

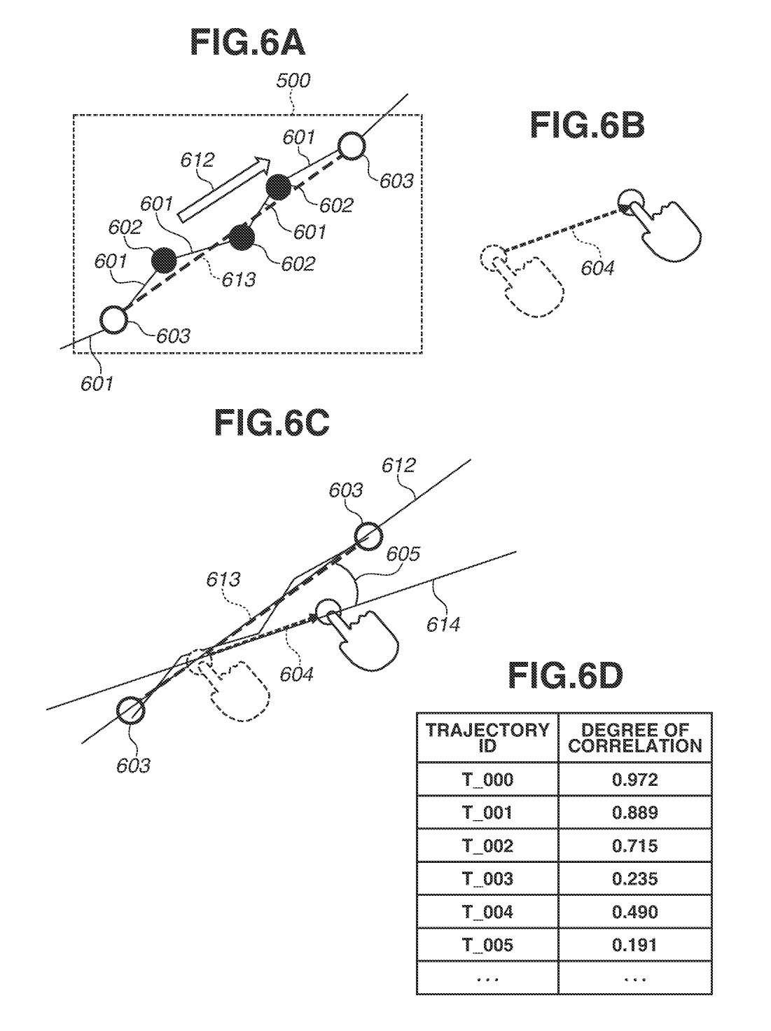

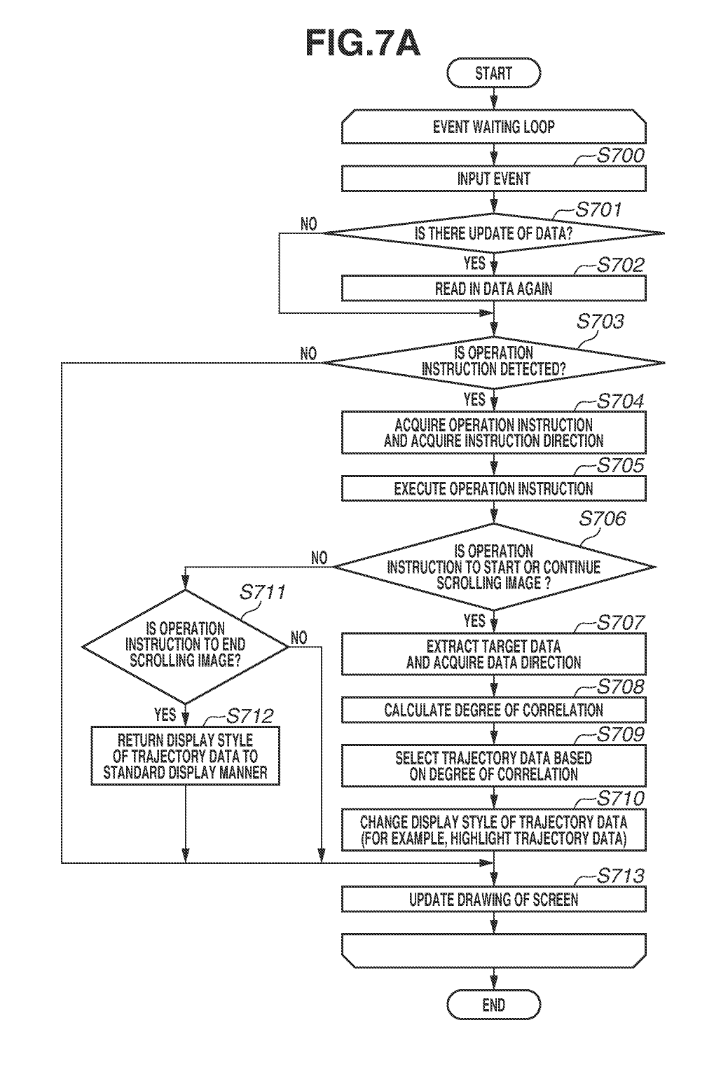

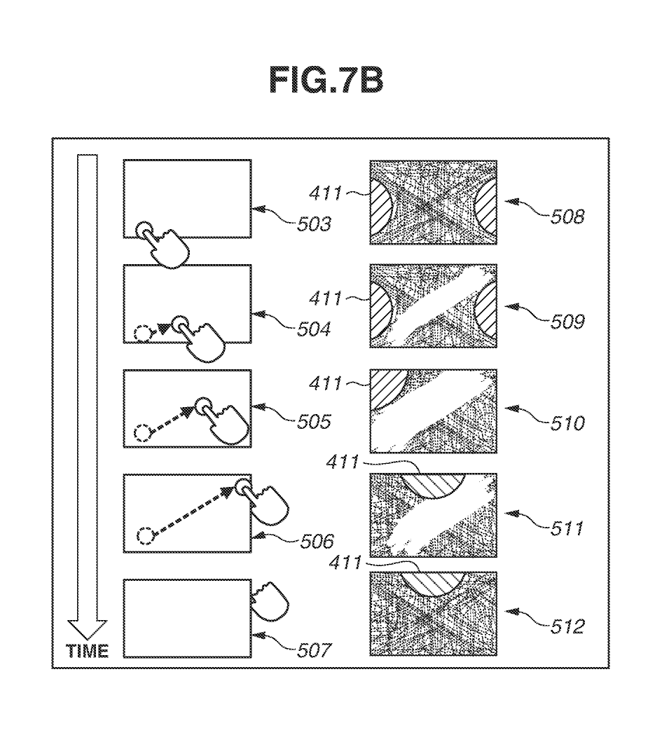

Next, an example of an operation of the data browse apparatus 100 according to the present exemplary embodiment will be described with reference to FIGS. 5A and 5B, FIGS. 6A, 6B, 6C, and 6D, and FIGS. 7A and 7B. FIGS. 5A and 5B illustrate an example of an operation performed on the data browse apparatus 100. FIGS. 6A, 6B, 6C, and 6D illustrate an example of calculating a degree of correlation between input vector data input from the operation input unit 104, and the trajectory data. FIG. 7A is a flowchart illustrating the operation of the data browse apparatus 100. In the following description, the flowchart is assumed to be realized by the CPU executing the control program. In FIG. 7A, an entire process (S700 to S713) is configured as an event waiting loop, which is executed being triggered by the detection of an input of an event, such as a change made to the data and an operation performed on the screen.

In step S700, the surveillant 206 performs an operation on the touch panel (the operation input unit 104) of a browse screen 500 (the display unit 102) with the user's finger, by which the event is input into the data browse apparatus 100. The operation performed on the screen is detected as the input of the event, which triggers the execution of the flow according to the present exemplary embodiment that is illustrated in FIG. 7A. When the touch panel (the operation input unit 104) detects the input of the event, the processing proceeds to step S701, in which the data update unit 151 checks whether there is an update of the data (for example, the browse data such as the trajectory data) displayed on the screen.

If the data update unit 151 detects an update of the data (YES in step S701), the processing proceeds to step S702, in which the data is read in again. Then, the processing proceeds to step S703. If the data update unit 151 detects no update of the data (NO in step S701), the processing proceeds to step S703.

In step S703, the touch panel (the operation input unit 104) functions as an operation instruction detection unit, and detects an operation instruction input by a movement of the finger of the surveillant 206 to thereby detect whether there is an operation instruction. If an operation instruction is detected (YES in step S703), the processing proceeds to step S704. If no operation instruction is detected (NO in step S703), the processing proceeds to step S713.

In the present exemplary embodiment, suppose that the surveillant 206 moves the user's finger toward an upper right side on the touch panel (the operation input unit 104), by which a movement instruction 501 issued to the data browse apparatus 100 is detected, as illustrated in FIG. 5A. If the touch panel (the operation input unit 104) detects the movement instruction 501 (YES in step S703), the processing proceeds to step S704.

In step S704, the instruction execution unit 152 performs processing for acquiring the operation instruction. The operation instruction may be various kinds of operation instructions input from the operation input unit 104. Further, the instruction execution unit 152 functions as the instruction direction acquisition unit, and acquires a direction input from the operation input unit 104 as the instruction direction. In FIG. 5A, the instruction execution unit 152 acquires a movement direction and a movement distance based on the movement instruction 501 as the input vector data (the instruction direction). In addition, the instruction execution unit 152 may acquire data such as the direction or the angle input from the mouse, a touch pen, or the gyro sensor, or the orientation input from the electronic compass as the input vector data (the instruction direction).

In step S705, the instruction execution unit 152 executes the operation instruction according to the operation instruction acquired in step S704. For example, the instruction execution unit 152 functions as a display range movement unit, and moves a display range of the display unit 102 along the input vector data (the instruction direction). In FIG. 5A, the instruction execution unit 152 scrolls the image displayed on the browse screen 500 according to the movement instruction 501 directed toward the upper right side. As illustrated in FIG. 5B, the scroll of the image causes a browse region (a display range) 502 displayed on the browse screen 500 to be moved to a lower left side of the monitoring space 201. In addition, the instruction execution unit 152 may enlarge or reduce the browse region 502 according to the operation instruction.

In step S706, the instruction execution unit 152 determines whether the operation instruction is an instruction to start or continue scrolling the image. If the operation instruction is the instruction to start or continue scrolling the image (YES in step S706), the processing proceeds to step S707.

In step S707, the target data extraction unit 153 extracts the browse data (hereinafter, referred to as “target data”) to be used to calculate the degree of correlation with the input vector data among pieces of browse data displayed on the browse screen 500. In the present exemplary embodiment, the trajectory data contained in the browse region (the display range) 502 of the browse screen 500 and the trajectory data located near the browse region 502 are extracted as the target data. Further, the target data extraction unit 153 functions as the data direction acquisition unit, and acquires a line direction of the trajectory data as the data direction.

The trajectory data located near the browse region 502 is extracted to allow the nearby trajectory data to be smoothly displayed on the browse screen 500 when the screen is scrolled. Further, the target data is limited to these pieces of trajectory data to reduce a load of processing for calculating the degree of correlation. For example, if the processing for calculating the degree of correlation should be performed on the trajectory data in a wide region, or if the load of the processing for calculating the degree of correlation does not have to be reduced due to availability of plenty of resources assignable to the calculation, more pieces of trajectory data may be extracted.

In step S708, the degree-of-correlation acquisition unit 154 calculates the degree of correlation with the input vector data input from the operation input unit 104 with respect to the trajectory data extracted as the target data. For example, the degree-of-correlation acquisition unit 154 calculates a cosine value of an angle formed between the direction of the input vector data and the direction of the trajectory data. In the present exemplary embodiment, the cosine value is calculated as the degree of correlation, so that the input vector data (the instruction direction) only has to contain at least data regarding the direction.

As illustrated in FIG. 6A, a direction of a line segment 613 connecting two observation points (selected points 603) selected from observation points 602 of the trajectory data contained in the browse screen 500 may be used as a data direction 612 of trajectory data 601. In this case, the degree-of-correlation acquisition unit 154 may automatically select two observation points on both outermost ends contained in the display region 502 of the browse screen 500 as the selected points 603. Further, two observation points (the selected points 603) may be selected by the operation input unit 104 (for example, a click of the mouse or a touch with the finger).

In addition thereto, the data direction 612 of the trajectory data 601 may be determined with use of a direction of a line segment defined by selecting points on both ends among the observation points 602 contained in the trajectory data 601 (including an observation point located outside the display region 502 of the browse screen 500) as the selected points 603, an average of directions of line segments each connecting adjacent two observation points (including the observation point located outside the display region 502 of the browse screen 500), and a direction of a line segment acquired by sampling trajectory data a predetermined time before a latest observation point. Further, the data direction 612 of the trajectory data 601 may be determined with use of a direction of a line segment acquired by sampling trajectory data having a predetermined length from the latest observation point, an orientation of a person detected by detection of a human body, and the like.

Further, if the trajectory data (the line data) 601 is a movement of the point data, the data direction 612 of the trajectory data 601 may be determined with use of a direction of a line segment connecting two points corresponding to an arbitrary movement time period or a direction of a line segment connecting two points corresponding to an arbitrary movement distance. Further, the data direction 612 of the trajectory data 601 may be determined with use of a direction of a line segment connecting two points on the trajectory data (the line data) located near a start point and an end point of the instruction direction. The two points in this case may be two observation points.

In this manner, the target data extraction unit (the data direction acquisition unit) 153 acquires, as the data direction, a tangential direction of the line data, the direction of the line segment connecting arbitrary two points (two observation points) on the line data that are displayed on the browse screen 500 (the display unit 102), or the direction of the line segment connecting arbitrary two points (two observation points) on the line data including the point (the observation point) on the line data that is not displayed on the browse screen 500 (the display unit 102). Further, the target data extraction unit (the data direction acquisition unit) 153 may acquire an average of the plurality of directions of line segments as the data direction.

As illustrated in FIG. 6B, the surveillant 206 moves the user's finger on the touch panel (the operation input unit 104), by which the instruction execution unit (the instruction direction acquisition unit) 152 acquires input vector data 604. For example, the input vector data 604 is acquired with use of a line segment connecting a point where the finger starts touching the touch panel and a point where the finger is separated from the touch panel.

As illustrated in FIG. 6C, the degree-of-correlation acquisition unit 154 calculates a cosine value of a relative angle 605 between a direction 614 of the input vector data 604 and the data direction 612 of the trajectory data 601 as the degree of correlation. In step S708, the degree-of-correlation acquisition unit 154 calculates the relative angle with the input vector data 604 and the cosine value thereof with respect to each of a plurality of pieces of target data (for example, pieces of trajectory data about the plurality of pedestrians 202).

As illustrated in FIG. 6D, the correlation table generation unit 155 generates a correlation table by associating the degree of correlation between the trajectory data 601 (the target data) and the input vector data 604 with the trajectory ID.

In steps S709 and S710, the display change unit 156 selects trajectory data having a highest degree of correlation based on the degree of correlation stored in the correlation table, and highlights the selected trajectory data on the browse screen 500 (the display unit 102). Further, the display change unit 156 may highlight trajectory data having a degree of correlation that is a predetermined threshold value or higher.

In the present exemplary embodiment, the movement instruction 501 determines a scroll direction of the browse screen 500, and also determines the input vector data (the instruction direction) 604 along therewith. In this case, the instruction execution unit 152 functions as the display range movement unit and the instruction direction acquisition unit. The movement instruction 501 causes the browse screen 500 to be scrolled, and the trajectory data having the high degree of correlation to be highlighted on the browse screen 500 at the same time.

The scroll direction is a lower left direction in the monitoring region as illustrated in FIG. 5B, but the direction 614 of the input vector data 604 is an upper right direction as illustrated in FIG. 6B. In this case, the trajectory data directed in the upper right direction that has the high degree of correlation with the input vector data 604 directed in the upper right direction is highlighted. On the other hand, the browse screen 500 is scrolled in an opposite direction (the lower left direction) from the upper right direction in which the highlighted trajectory data is directed, and this means that the browse screen 500 displays the observation points while tracing back the time axis (in a backward direction of the time axis) according to the scroll.

If the relative angle 605 is 60 degrees, 0.5 is acquired as the cosine value. If the relative angle 605 is 240 degrees, −0.5 is acquired as the cosine value. In other words, if the movement instruction 501 is reversed in direction, the direction 614 of the input vector data 604 is changed by 180 degrees, and the cosine value is changed from a positive value to a negative value (or from a negative value to a positive value). If the degree of correlation is calculated regardless whether the movement instruction 501 is directed in an opposite direction, the degree-of-correlation acquisition unit 154 calculates an absolute value of the cosine value as the degree of correlation.

Further, when the browse screen 500 displays the observation points while tracing forward the time axis (in a forward direction of the time axis) according to the scroll of the browse screen 500, the degree-of-correlation acquisition unit 154 calculates a value acquired by multiplying the cosine value by −1 as the degree of correlation. For example, if the surveillant 206 moves the user's finger on the touch panel (the operation input unit 104) in the opposite direction (the lower left direction) from the data direction 612 of the trajectory data 601, a movement instruction directed in the lower left direction is input, and input vector data directed in the lower left direction is acquired.

In this case, when the degree-of-correlation acquisition unit 154 calculates the value acquired by multiplying the cosine value by −1 as the degree of correlation, trajectory data 610 directed in the opposite direction (the upper right direction) from the input vector data directed in the lower left direction is highlighted. Then, the browse screen 500 is scrolled in the same direction (the upper right direction) as the highlighted trajectory data 610, and this means that the browse screen 500 displays the observation points while tracing forward the time axis (in the forward direction of the time axis) according to the scroll.

Further or alternatively, the degree-of-correlation acquisition unit 154 may calculate an inner product of trajectory vector data and the input vector data 604 as the degree of correlation by using the direction and a length of the line segment used to acquire the data direction 612 of the trajectory data 601 as the trajectory vector data. Calculating the degree of correlation in this manner allows longer trajectory vector data to have a higher degree of correlation among or between pieces of trajectory vector data if they form same relative angles, whereby the long trajectory data is highlighted preferentially even under such a situation that the long trajectory data blends into the other trajectory data on the browse screen 500. As a result, the surveillant 206 can trace a flow of the trajectory while scrolling the browse screen 500 without losing track thereof.

Further, the degree-of-correlation acquisition unit 154 may calculate a value acquired by multiplying the above-described inner product value by a reciprocal of a distance between the trajectory vector data and the input vector data 604 as the degree of correlation. Calculating the degree of correlation in this manner allows trajectory data located near the input vector data 604 to have a higher degree of correlation than a degree of correlation of trajectory data located away from the input vector data 604, whereby the nearby trajectory data is highlighted preferentially, as a result of which the surveillant 206 can differentiate a desired trajectory located near the movement instruction 501.

The present exemplary embodiment can be realized by arbitrarily selecting these degrees of correlation according to a purpose of use. The present exemplary embodiment can be realized as long as the degree-of-correlation acquisition unit 154 calculates the degree of correlation based on at least one of the angle between the data direction and the instruction direction, the distance between the acquisition position of the data and the acquisition position of the instruction direction, and the inner product of the data and the instruction direction.

Further, whether to select the trajectory data having the high degree of correlation or select the trajectory data having the low degree of correlation may be arbitrarily determined according to the purpose and intended use of the surveillant 206. In step S709, the display change unit 156 may select at least one of trajectory data having a degree of correlation that is a threshold value or lower, trajectory data having a degree of correlation, an absolute value of which is a threshold value or higher, and trajectory data having a degree of correlation, an absolute value of which is a threshold value or lower. In this manner, the display change unit 156 can set a range of a reference degree of correlation based on which the trajectory data is selected.

The display change unit 156 highlights the data having the degree of correlation that is the predetermined threshold value or higher, or the predetermined threshold value or lower, on the display unit 102.

Further, in step S710, the trajectory data can be displayed in various display styles on the browse screen 500 (the display unit 102). In other words, the trajectory data is displayed in a display style that makes the trajectory data that is selected (hereinafter, referred to as “selected trajectory data”) discernible from the trajectory data that is not selected (hereinafter referred to as “unselected trajectory data”).

For example, the display unit 102 may display a color of the selected trajectory data in a different color from a color of the unselected trajectory data to thereby highlight the selected trajectory data having the high degree of correlation while the browse screen 500 is scrolled. At this time, the display unit 102 may change a width, a shade, a brightness, a color tone, a transparency, and the like of the trajectory data according to the degree of correlation to further improve the visibility of the selected trajectory data.

Further, if a large number of pieces of trajectory data are displayed while being superimposed on one another, the display change unit 156 may sort the pieces of trajectory data based on the degree of correlation so as to prevent the trajectory data that the surveillant 206 pays attention to from being hidden by the other trajectory data. In this case, the display unit 102 may draw the trajectory data in an order according to a result of the sort. The display change unit 156 may display the data in an order of the degree of correlation, starting from the data having the highest degree of correlation or staring from the data having the lowest degree of correlation, on the display unit 102.

After the display change unit 156 changes the display style of the trajectory data in step S710, the processing proceeds to step S713. On the other hand, if the operation instruction is the instruction neither to start nor to continue scrolling the image in step S706 (NO in step S706), the processing proceeds to step S711. In step S711, the instruction execution unit 152 determines whether the operation instruction is an instruction to end scrolling the image. If the operation instruction is the instruction to end scrolling the image (YES in step S711), the processing proceeds to step S712, in which the display unit 102 returns the display style of the trajectory data to a standard display style. If the operation instruction is not the instruction to end scrolling the image (NO in step S711), the processing proceeds to step S713.

In step S713, the display unit 102 changes screen drawing of the browse screen 500 according to the processing of steps S700 to S712. For example, the display unit 102 changes the browse region 502 of the browse screen 500 and the display style according to an enlargement or a reduction of the browse region 502 and the display style of each piece of data. This is followed by a transition to a state waiting for an input of a next event.

FIG. 7B illustrates a temporal example of the operation instruction input into the data browse apparatus 100, corresponding to the scroll and the input vector data illustrated in FIGS. 5A and 5B. The touch panel (the operation input unit 104) inputs operation instructions 503 to 507. Browse screens 508 to 512 correspond to the operation instructions 503 to 507, respectively.

In step S700, the surveillant 206 touches the touch panel (the operation input unit 104) with the user's finger, by which the operation instruction 503 is input as the event. In this case, in steps S701 and S702, the finger still touches the touch panel, so that the browse screen 508 is in an initial state.

In steps S703 to S705, the surveillant 206 moves the user's finger to the upper right side on the touch panel (the operation input unit 104), by which the operation instruction 504, 505, or 506 is input. If the operation instruction 504, 505, or 506 is the instruction to start or continue scrolling the image (YES in step S706), in step S707, the target data extraction unit 153 extracts the trajectory data displayed on the browse screen 509, 510, or 511. Then, in step S708, the degree-of-correlation acquisition unit 154 calculates the degree of correlation with the input vector data (the operation instruction) based on the movement instruction 504, 505, or 506 with respect to the trajectory data.

In FIG. 7B, a high value is acquired from calculation of the degree of correlation of the trajectory data directed in the upper right direction. Therefore, in steps S709, S710, and S713, the display change unit 156 selects the trajectory data having the degree of correlation that is the predetermined threshold value or higher, and highlights the selected trajectory data on the browse screen 509, 510, or 511.

In step S711, the surveillant 206 separates the user's finger from the touch panel (the operation input unit 104), by which the operation instruction 507 is input as the end of the scroll. Then, in steps S712 and S713, the display unit 102 ends the highlighted display of the trajectory data, and returns the display style of the trajectory data on the browse screen 512 to the standard display style.

In this manner, the data browse apparatus 100 changes the display style of the browse data on the scrolled screen according to the degree of correlation after acquiring the input vector data from the operation instruction (the movement instruction) and calculating the degree of correlation with the input vector data with respect to each piece of browse data (spatial data). Regarding these processing procedures, the operation instructions are continuously input, which causes the browse screen to be continuously scrolled in various directions according to the operation instructions and causes the browse data to be continuously highlighted on the browse screen along therewith.

With this configuration, the data browse apparatus 100 can improve the visibility due to the highlighted display of the browse data even under such a situation that the browse data is displayed with low visibility because pieces of browse data (spatial data) intersect with one another in a complicated manner. As a result, the surveillant 206 can be prevented from losing track of the flow of the trajectory that the surveillant 206 has been tracing while scrolling the screen. Further, the display style of the browse data is returned upon the end of the scroll, which eliminates the necessity of switching a display mode of the browse data or the like, thereby contributing to a reduction in a load imposed on the surveillant 206 for browsing the data.

These effects are helpful especially when the surveillant 206 rapidly scrolls the screen to monitor a wide monitoring region.

Further, the data browse apparatus 100 can also emphasize the change in the display style of the browse data by using a transition effect or the like, to improve the visibility when the surveillant 206 browses the browse data. Further, the data browse apparatus 100 may improve the visibility when the surveillant 206 browses the browse data by maintaining the display style in the changed state (for example, the highlighted state) without returning the display style of the browse data.

Further, when the browse data is selected based on the degree of correlation, the correlation table generation unit 155 generates, for example, a histogram of the degrees of correlation based on the correlation table, and the display change unit 156 selects a group corresponding to a frequency that is a predetermined threshold value or lower. The display unit 102 highlights the browse data belonging to this group, thereby allowing the surveillant 206 to easily find out the browse data buried in the other browse data as a data group including a small number of pieces of data.

Further, the present exemplary embodiment has been described, referring to the example in which the browse data (the spatial data) displayed on the browse screen is two-dimensional data. However, the data browse apparatus 100 may be a browse apparatus including a user interface that displays browse data (spatial data) that is three-dimensional data including a height, a depth, and the like.

Further, the present exemplary embodiment has been described referring to the example in which the browse data is the trajectory data, but can also be applied for browse data such as the line graph, the tree structured data, and the social map, in addition to the spatial data such as the trajectory data.

The present exemplary embodiment is useful especially to track specific browse data while scrolling the browse screen when a scale and an information amount of the browse screen desired by the surveillant 206 are insufficient to allow the browse data to be contained in the browse screen (the display range). Further, the present exemplary embodiment is also useful in a similar manner, when the browse data is contained in the browse screen (the display range) but the visibility reduces because a large number of pieces of data are displayed while overlapping one another. This situation corresponds to browsing the data within the fixed display range without moving the display range by the instruction direction. In either case, the data browse apparatus 100 acquires the data direction with use of a part or a whole of the target data that is the browse data to be tracked, similarly to the present exemplary embodiment. Then, the data browse apparatus 100 calculates the degree of correlation (for example, the cosine value or the inner product) between the acquired data direction and the input vector data (the instruction direction), and changes the display style of the target data having the predetermined degree of correlation. Controlling the display in this manner facilitates tracking the data extending across screens when the browse data is not contained in the browse screen, which has been described as the former case. On the other hand, when the browse data is contained in the browse screen, which has been described as the latter case, this display control causes a part of the large number of pieces of data to be highlighted according to the input vector data, thereby facilitating understanding what kind of data exists on the screen.

Further, the degree-of-correlation acquisition unit 154 may weight the degree of correlation based on an attribute value owned by the browse data. For example, the degree-of-correlation acquisition unit 154 may weight the degree of correlation by using a time period during which the browse data stays at the observation point and how much a neighborhood is congested as a weighting coefficient. In this case, the degree-of-correlation acquisition unit 154 multiplies trajectory data staying for a long time and trajectory data located around a highly congested neighborhood by a larger weighting coefficient, which leads to a highlighted display of trajectory data located in a highly populated monitoring region, thereby contributing to the improvement of the visibility for the surveillant 206 that detects congestion.

A second exemplary embodiment will be described using an example of a multi-touch, in which the surveillant 206 performs an operation on the touch panel (the operation input unit 104) with a plurality of the user's fingers. More specifically, the data browse apparatus 100 changes the display style with use of the degree of correlation according to a plurality of input points input from the operation input unit 104.

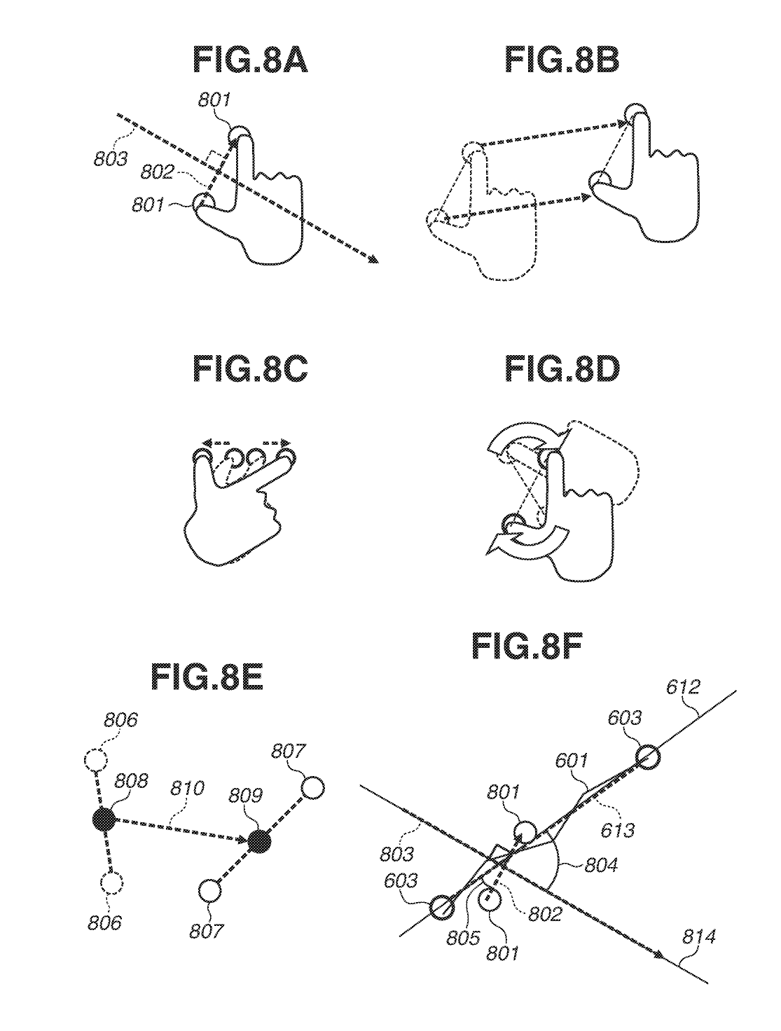

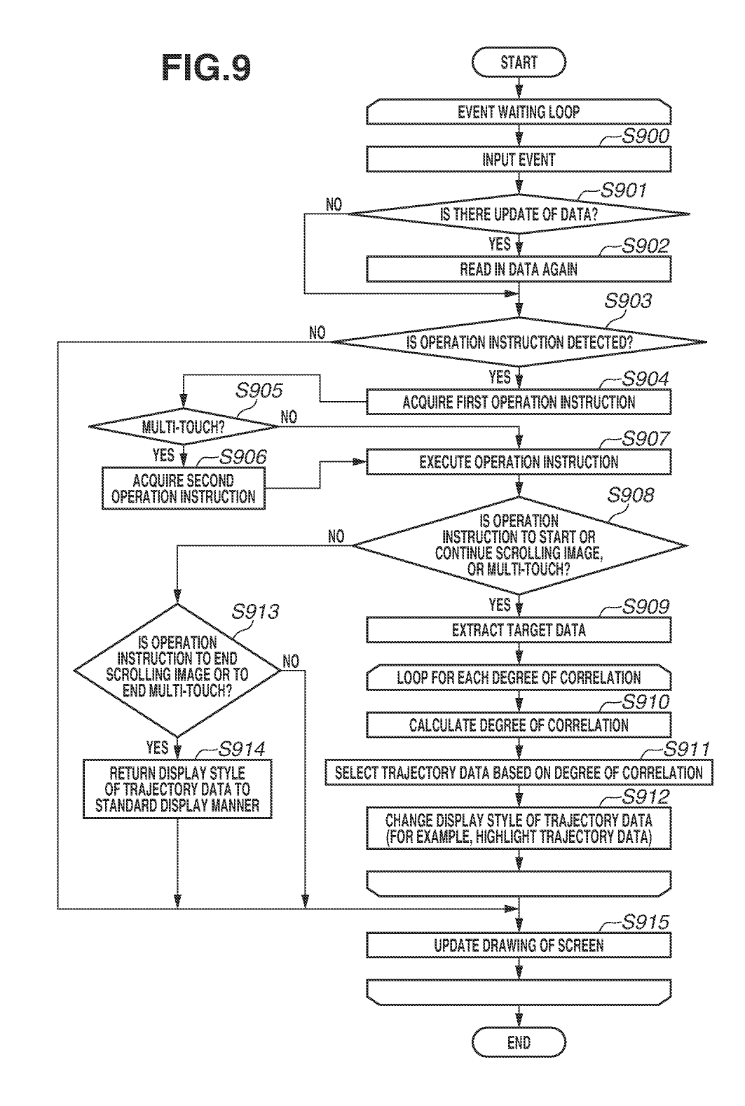

The data browse apparatus 100 according to the present exemplary embodiment includes similar components to the data browse apparatus 100 according to the first exemplary embodiment. An example of an operation of the data browse apparatus 100 according to the present exemplary embodiment will be described with reference to FIGS. 8A, 8B, 8C, 8D, 8E, and 8F, and FIG. 9. The present exemplary embodiment will be described, omitting descriptions of similar configurations, functions, and operations to the first exemplary embodiment, and mainly focusing on differences from the first exemplary embodiment.

FIGS. 8A, 8B, 8C, 8D, 8E, and 8F illustrate that a plurality of operation instructions is input from the operation input unit 104. FIG. 9 is a flowchart illustrating an operation of the data browse apparatus 100 according to the present exemplary embodiment.

In FIG. 9, steps S905 and S906 are inserted in processing corresponding to steps S704 to S713 illustrated in FIG. 7A, and steps S910 to S912 form a loop structure. Steps S900 to S903 and S909 correspond to steps S700 to S703 and S707 illustrated in FIG. 7A, respectively.

In step S904, the instruction execution unit 152 performs processing for acquiring a first operation instruction. The operation instruction may be various kinds of operation instructions input from the operation input unit 104. For example, the surveillant 206 performs an operation on the touch panel (the operation input unit 104) of the browse screen 500 (the display unit 102) with a plurality of the user's fingers. After acquiring the number of input points of the operation instructions, the instruction execution unit 152 acquires coordinates, a movement distance, a movement direction, and the like for each input point.

In step S905, the instruction execution unit 152 determines whether a plurality of input points is input (the multi-touch). If the plurality of input points is input (YES in step S905), the processing proceeds to step S906. If the plurality of input points is not input (NO in step S905), the processing proceeds to step S907.

In step S906, the instruction execution unit 152 acquires a second operation instruction based on the plurality of input points.

For example, FIGS. 8A, 8B, 8C, 8D, 8E, and 8F illustrate that the surveillant 206 performs an operation on the touch panel (the operation input unit 104) with the user's two fingers. As illustrated in FIG. 8A, the instruction execution unit 152 acquires two input points 801 corresponding to positions of the two fingers, and acquires an orthogonal vector 803 orthogonal to a line segment 802 at a midpoint of the line segment 802 connecting the two input points 801 as the input vector data (the instruction direction).

Further, the instruction execution unit 152 acquires the second operation instruction, such as an operation instruction in which the surveillant 206 drags the user's two fingers on the touch panel (the operation input unit 104) as illustrated in FIG. 8B, an operation instruction in which the surveillant 206 performs a pinch operation on the touch panel (the operation input unit 104) with the user's two fingers to thereby enlarge or reduce the browse region 502 as illustrated in FIG. 8C, and an operation instruction in which the surveillant 206 performs a pinch operation on the touch panel (the operation input unit 104) with the user's two fingers to thereby rotate the browse region 502 as illustrated in FIG. 8D.

The second operation instruction is an operation instruction of various kinds of operation instructions input from the operation input unit 104 via the multi-touch. In this case, input vector data, an enlargement rate, a reduction rate, a rotational angle, and the like acquired from a change in the plurality of input points may be acquired as data indicating the second operation instruction. Further, the instruction execution unit (the instruction direction acquisition unit) 152 may receive a plurality of operation instructions at the same time.

For example, the surveillant 206 may drag the user's fingers as illustrated in FIG. 8B in a state of the pinch operation illustrated in FIG. 8A. The instruction execution unit (the instruction direction acquisition unit) 152 may scroll the display range in a drag direction and acquire a scroll direction as the instruction direction, and acquire the orthogonal vector 803 as the instruction direction along therewith. In other words, two pieces of input vector data (two instruction directions) are acquired at the same time.

Further, the surveillant 206 may enlarge or reduce the browse region 502 as illustrated in FIG. 8C in the state of the pinch operation illustrated in FIG. 8A. The instruction execution unit (the instruction direction acquisition unit) 152 can enlarge or reduce the display range in an enlargement direction or a reduction direction illustrated in FIG. 8C, and acquire the orthogonal vector 803 illustrated in FIG. 8A as the input vector data (the instruction direction) along therewith.

Further, the surveillant 206 may rotate the browse region 502 as illustrated in FIG. 8D in the state of the pinch operation illustrated in FIG. 8A. The instruction execution unit (the instruction direction acquisition unit) 152 can rotate the display range in a rotational direction illustrated in FIG. 8D, and acquire the orthogonal vector 803 illustrated in FIG. 8A as the input vector data (the instruction direction) along therewith.

Further, the surveillant 206 drags the user's two fingers on the touch panel (the operation input unit 104) as illustrated in FIG. 8E. The instruction execution unit 152 acquires two input points 806 corresponding to positions of the two fingers that are a start point of the drag, and two input points 807 corresponding to positions of the two fingers that are an end point of the drag. The instruction execution unit 152 acquires a straight line connecting a midpoint 808 between the input points 806 and a midpoint 809 between the input points 807 as input vector data 810.

In step S907, the instruction execution unit 152 executes the operation instructions according to the first and second operation instructions acquired by the instruction execution unit 152 in steps S904 and S906, respectively. For example, the instruction execution unit 152 scrolls the image on the browse screen 500, or enlarges or reduces the browse region 502. Further, the instruction execution unit (the instruction direction acquisition unit) 152 acquires the instruction direction based on at least one of a touch, a click, a scroll, a drag, a rotation, an angle, an angular speed, and an orientation input from the input unit.

In step S908, the instruction execution unit 152 determines whether the operation instruction is an instruction to start or continue scrolling the image, or to input the multi-touch. If the operation instruction is the instruction to start or continue scrolling the image, or to input the multi-touch (YES in step S908), the processing proceeds to step S909.

In step S909, the target data extraction unit 153 extracts the target data. Then, the processing proceeds to the loop of steps S910 to S912. In step S910, the degree-of-correlation acquisition unit 154 calculates the degree of correlation with the input vector data (the instruction direction) with respect to the trajectory data that is the target data. For example, the degree-of-correlation acquisition unit 154 calculates a cosine value of an angle formed between a direction of the input vector data 803 or 810, and the direction of the trajectory data. In the present exemplary embodiment, the cosine value is calculated as the degree of correlation, whereby the input vector data 803 or 810 only has to contain at least data regarding the direction.

For example, as illustrated in FIG. 8F, the degree-of-correlation acquisition unit 154 calculates a cosine value of a relative angle 804 between a data direction 814 of the input vector data 803 and the data direction 612 of the trajectory data 601 as the degree of correlation. Further, the degree-of-correlation acquisition unit 154 may calculate a cosine value of a relative angle 805 between the line segment 802 and the data direction 612 of the trajectory data 601 as the degree of correlation. The degree-of-correlation acquisition unit 154 can acquire the instruction direction to calculate the degree of correlation even when the surveillant 206 does not move the user's fingers on the touch panel (the operation input unit 104), by calculating the degree of correlation with use of the line segment 802 connecting the two input points 801.

Further, if the two pieces of input vector data (the two instruction directions) are acquired at the same time, the degree-of-correlation acquisition unit 154 calculates the cosine value of the relative angle with the data direction as the degree of correlation for each of the instruction directions.

In step S911, the display change unit 156 selects the data based on the degree of correlation, similarly to step S709 in the first exemplary embodiment. In step S912, the display change unit 156 changes the display style regarding the selected data so as to make the data distinguishable for each degree of correlation. If the operation instruction is the instruction neither to start nor scrolling the image, nor to input the multi-touch in the above-described step S908 (NO in step S908), the processing proceeds to step S913.

In step S913, the instruction execution unit 152 determines whether the operation instruction is an instruction to end scrolling the image. If the operation instruction is the instruction to end scrolling the image (YES in step S913), the processing proceeds to step S914. Then, the display unit 102 returns the display style to the standard display style regarding the data. If the operation instruction is not the instruction to end scrolling the image (NO in step S913), the processing proceeds to step S915. In step S915, the display unit 102 issues an instruction to the display control unit 120 according to the display style regarding the browse region (the display range) 502 and each piece of data determined in the above-described processing, thereby updating the drawing of the screen. Then, the processing proceeds to the waiting state for an input of a next event.

In this manner, the instruction execution unit (the instruction direction acquisition unit) 152 acquires the instruction direction based on the operation instruction input from the input unit, and the target data extraction unit (the data direction acquisition unit) 153 acquires the trajectory data. Then, the degree-of-correlation acquisition unit 154 calculates the degree of correlation with the instruction direction for each piece of trajectory data, and the display change unit 156 changes the display style for each degree of correlation. Further, the instruction execution unit (the instruction direction acquisition unit) 152 may acquire the two pieces of input vector data (the two instruction directions) at the same time.

The present exemplary embodiment allows the data browse apparatus 100 to incorporate more operations by utilizing the multi-touch operation and the like, and therefore provides an effect of preventing the surveillant 206 from losing track of the desired trajectory data that the surveillant 206 has been tracing with the user's own eyes in the browse region (the display range) 502 while scrolling the screen.

For example, when the surveillant 206 drags the user's fingers as illustrated in FIG. 8B in the above-described state of the pinch operation illustrated in FIG. 8A, the instruction execution unit (the instruction direction acquisition unit) 152 acquires the two pieces of input vector data (the two instruction directions) at the same time. At this time, the degree-of-correlation acquisition unit 154 highlights data having a high degree of correlation with the orthogonal vector 803 illustrated in FIG. 8A with use of another display style, in addition to highlighting data having a high degree of correlation with the drag direction (the instruction direction) illustrated in FIG. 8B.

As a result, the instruction execution unit (the instruction direction acquisition unit) 152 can acquire the input vector (the instruction direction) according to the pinch operation, in addition to the operation instruction of moving the viewpoint of the surveillant 206 by dragging the fingers to thereby scroll the browse region 502. With this configuration, the data browse apparatus 100 highlights the data having a higher degree of correlation with another instruction direction than with the scroll direction, and thereby can prevent the surveillant 206 from losing track of the desired data even while scrolling the screen.

It is also effective to use a cosine value of a relative angle between the input vector data 810 and the data direction as the degree of correlation as illustrated in FIG. 8E. The data browse apparatus 100 can highlight the data based on the instruction direction intended by the operator even when each of the input points exhibits a drastic or frequent change, by acquiring the instruction direction from the start point and the end point of the plurality of input points.

Further, even when the browse region 502 is rotated according to the operation instruction, the data browse apparatus 100 can maintain the highlighted display of the data having the high degree of correlation by rotating the instruction direction together with the rotation of the browse region 502. As a result, the data browse apparatus 100 can prevent the surveillant 206 from losing track of the desired data even when the screen is changed due to the rotational movement.

Other than that, it is also possible to use the direction or the angle detected by the gyro sensor, or the orientation detected by the electronic compass. The surveillant 206 performs an operation such as standing up, lying down, and rotating the data browse apparatus 100 such as a tablet terminal, thereby rotating the instruction direction via a change in the direction of gravity, the angle, and the orientation. As a result, the data browse apparatus 100 can dynamically highlight the data according to the intention of the surveillant 206 holding the data browse apparatus 100 and circumstances surrounding the data browse apparatus 100.

Now, in the flow illustrated in FIG. 9, the data browse apparatus 100 changes the display style regarding the data for each degree of correlation in the loop of steps S910 to S912. However, step S912 may be moved outside the loop, and the display change unit 156 may change the display style of the data while combining a plurality of degrees of correlation after the degree-of-correlation acquisition unit 154 calculates all degrees of correlation. This method can prevent or reduce an adverse effect of selecting all directions to highlight the data or excessively highlighting a single direction.

Further, the number of input points may be dynamically changed according to the data, the operation input, or the like. For example, if the data browse apparatus 100 has a pen input mode and a finger input mode, the pen input mode is not assumed to involve a plurality of input points. Therefore, even when a plurality of input points is input by mistake, the data browse apparatus 100 may omit the calculation of the degree of correlation based on this input. The data browse apparatus 100 can control the processing load by limiting the calculation of the degree of correlation according to the multi-touch in this manner.

In the example described in the present exemplary embodiment, the data browse apparatus 100 is assumed to handle one or two input point(s), but may handle three or more input points when a multi-touch function is enabled. More specifically, the instruction operation requesting the rotation may be input around a central point that is set to average coordinates of the three or more input points. Further, the data browse apparatus 100 may use the three or more input points two by two at a time to acquire the instruction direction for every two input points, and calculate the degree of correlation between each of the instruction directions and the data direction.

A third exemplary embodiment will be described as an example in which the operation instruction or the display style of the data is changed according to a change in the degree of correlation.

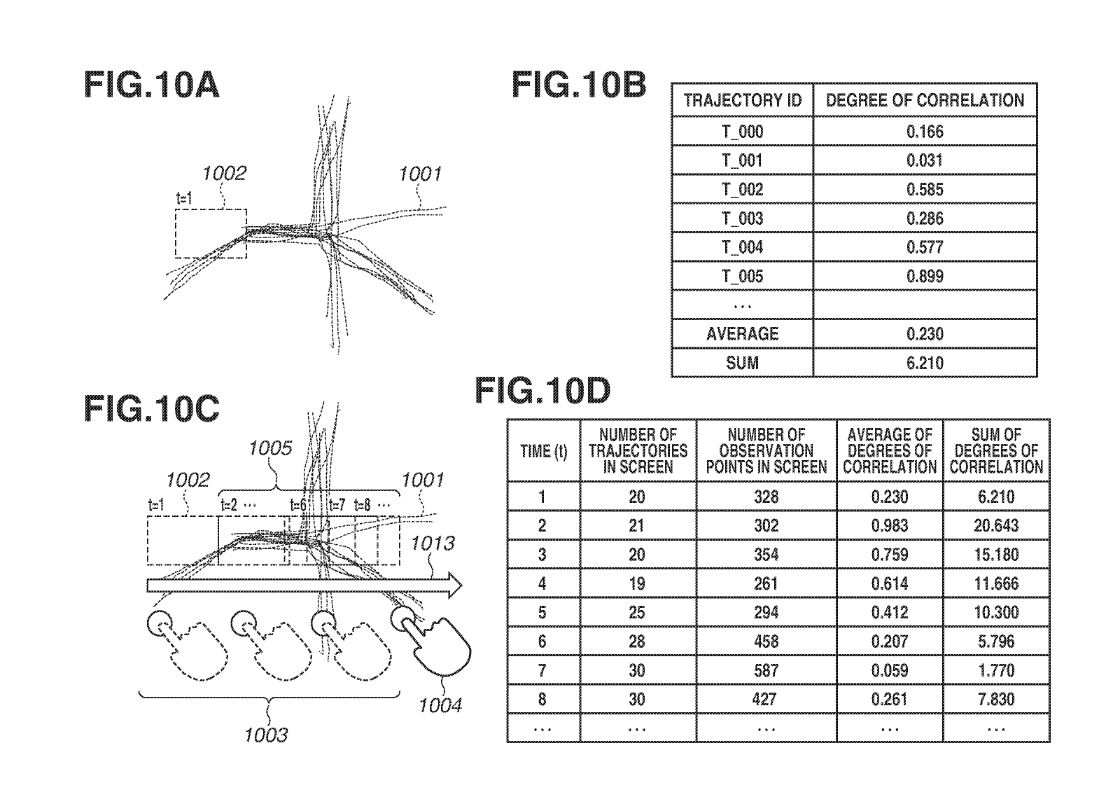

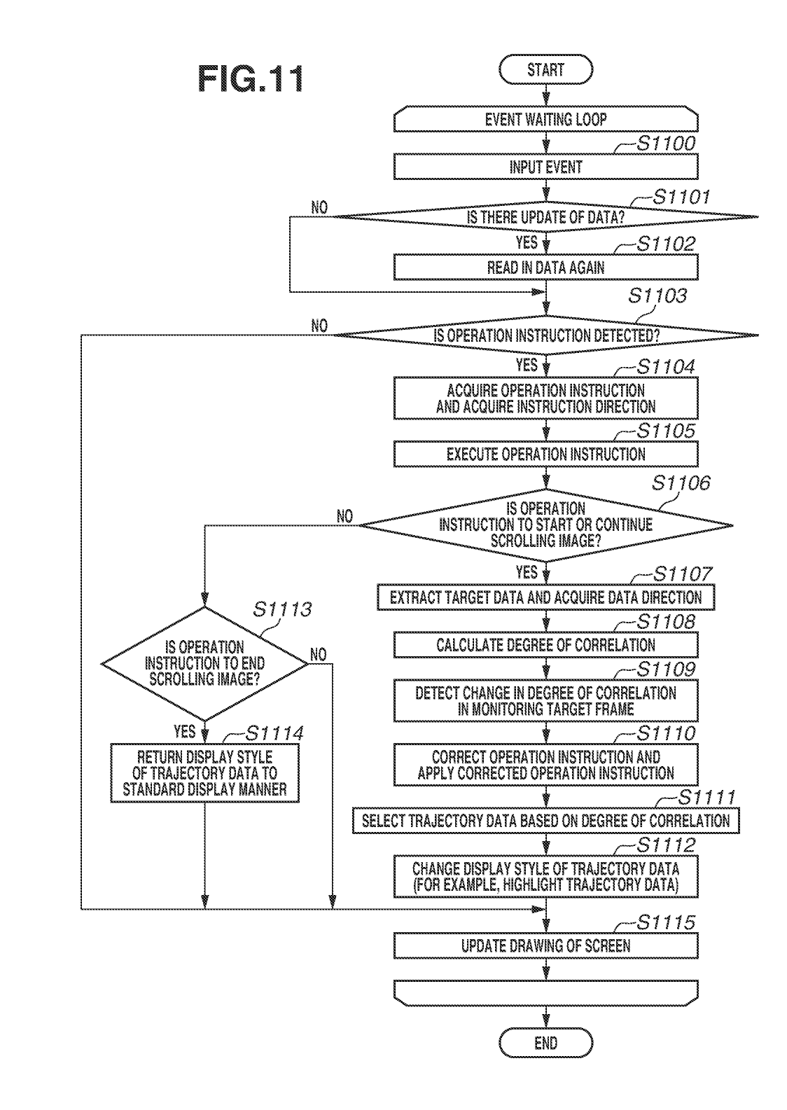

The data browse apparatus 100 according to the present exemplary embodiment includes similar components to the data browse apparatus 100 according to the first exemplary embodiment. An example of an operation of the data browse apparatus 100 according to the present exemplary embodiment will be described with reference to FIGS. 10A, 10B, 10C, and 10D, and FIG. 11. The present exemplary embodiment will be described, omitting descriptions of similar configurations, functions, and operations to those of the first exemplary embodiment, and mainly focusing on differences from the first exemplary embodiment.

FIGS. 10A, 10B, 10C, and 10D illustrate that the movement speed of the display range of the display unit 102 is changed according to the degree of correlation. FIG. 11 is a flowchart illustrating the operation of the data browse apparatus 100 according to the present exemplary embodiment.

In FIG. 11, steps S1109 and S1110 are inserted in processing corresponding to steps S704 to S713 illustrated in FIG. 7A, and steps S1100 to S1115 form a loop structure. Steps S1100 to S1108 and S1111 to S1115 correspond to steps S700 to S708 and S709 to S713 illustrated in FIG. 7A, respectively.

FIG. 10A illustrates an example of a trajectory data group (a line data group). In a trajectory data group 1001, the trajectory data branches into four directions on the right side after flowing from the left side. It is assumed that a browse region (a display range) 1002 is set in a space of the data of the trajectory data group 1001 flowing in this manner, and the surveillant 206 observes the inside of the browse region 1002. The browse region 1002 can be moved by being scrolled. At this time, in step S1105, the instruction execution unit 152 executes the operation instruction requesting the scroll, by which the browse region 1002 is moved.

In step S1108, the degree-of-correlation acquisition unit 154 calculates the degree of correlation between the data direction and the instruction direction. In step S1109, the degree-of-correlation acquisition unit 154 functions as a degree-of-correlation change detection unit, and monitors the degree of correlation in the browse region 1002 to detect a change therein. For example, the degree of correlation in the browse region 1002 changes under such a situation that a trajectory data group (a line data group) orientated in a same direction splits or branches.

FIG. 10B illustrates pieces of trajectory data observed at a predetermined time and degrees of correlation thereof. FIG. 10C illustrates that the browse region (the display range) 1002 is moved along an instruction direction 1013. In FIG. 10C, the movement speed of the browse region (the display range) 1002 is changed according to a sum of the degrees of correlation between the data directions of the pieces of trajectory data and the instruction direction at each time. FIG. 10D illustrates the number of pieces of trajectory data located in the browse region 1002, and an average and the sum of the degrees of correlation thereof.

In the example illustrated in FIGS. 10B, 10C, and 10D, the instruction execution unit 152 receives an operation instruction 1003 and an operation instruction 1004 that are continuously input. In response thereto, the instruction execution unit 152 functions as the display range change unit, and moves the browse region (the display range) 1002 from the left side to the right side along the instruction direction 1013. In other words, the instruction execution unit 152 scrolls the browse region (the display range) 1002. In this case, the sum of the degrees of correlation drastically reduces at times t=6 and t=7 when the browse region (the display range) 1002 passes through a position where the trajectory data branches, as illustrated in FIG. 10D.

In step S1110, the instruction execution unit (the display range movement unit) 152 increase/decrease a scroll speed or stops the scroll if the sum of the degrees of correlation between the data directions of the pieces of trajectory data and the instruction direction 1013 in the browse region (the display range) 1002, or a change amount thereof exceeds a predetermined threshold value. In FIG. 10C, the instruction execution unit (the display range movement unit) 152 reduces the scroll speed as the sum of the degrees of correlation of the pieces of trajectory data in the browse region (the display range) 1002 reduces. Therefore, the scroll speed is reduced when the browse region (the display range) 1002 passes through the branch position.

With this configuration, the data browse apparatus 100 can alert the surveillant 206 that a change occurs in distribution of the pieces of data in the browse region 1002. Further, the data browse apparatus 100 allows the surveillant 206 to avoid a risk of overlooking the occurrence of the change in the distribution of the pieces of data in the browse region 1002, by reducing the scroll speed.

According to the present exemplary embodiment, the surveillant 206 can acquire an effect of being able to detect the change in the data without carrying out a complicated analysis, and can detect an abnormality in the change in the data. In the above-described example, the data browse apparatus 100 uses the sum of the degrees of correlation of the pieces of data in the browse region 1002, but may use the average of the degrees of correlation instead of the sum of the degrees of correlation in consideration of an influence of an increase/reduction in the number of pieces of data in the browse region 1002.

Other than those, the data browse apparatus 100 can also generate the histogram of the degrees of correlation of the pieces of data in the browse region 1002 and use a change in a mode value among the degrees of correlation. This method allows the surveillant 206 to detect the change for each frequency value even when a plurality of pieces of data is distributed in a plurality of directions. Further, the instruction execution unit (the display range movement unit) 152 may change the movement direction (the scroll direction) of the display range of the display unit 102 according to the degree of correlation, other than increasing/reducing the scroll speed and stopping the scroll. For example, the instruction execution unit (the display range movement unit) 152 snaps the scroll direction of the browse region (the display range) 1002 in a direction in which the largest number of pieces of trajectory data branch off at the branch position of the trajectory data.

A fourth exemplary embodiment will be described as an example in which remote monitoring is carried out based on image data with use of a network camera, an unmanned airplane, or the like.

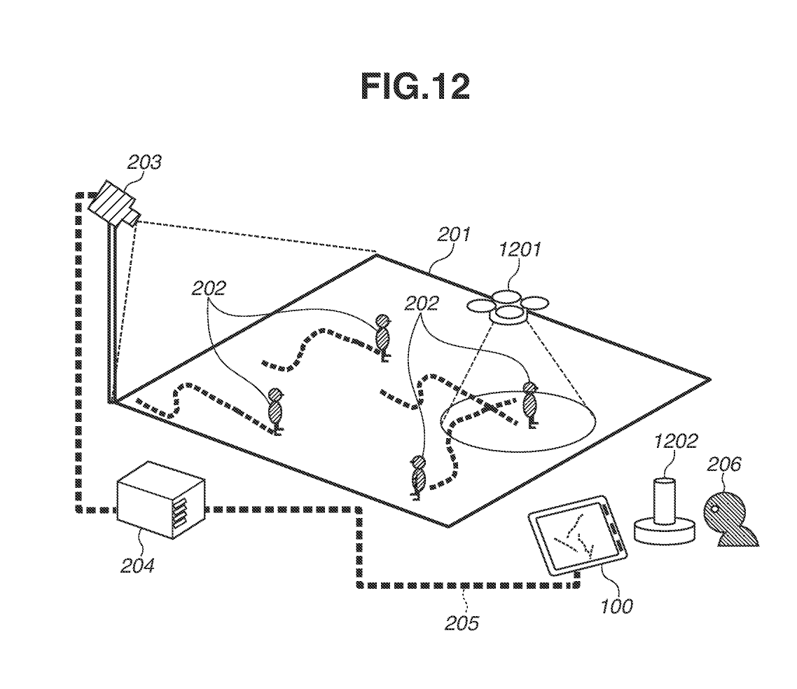

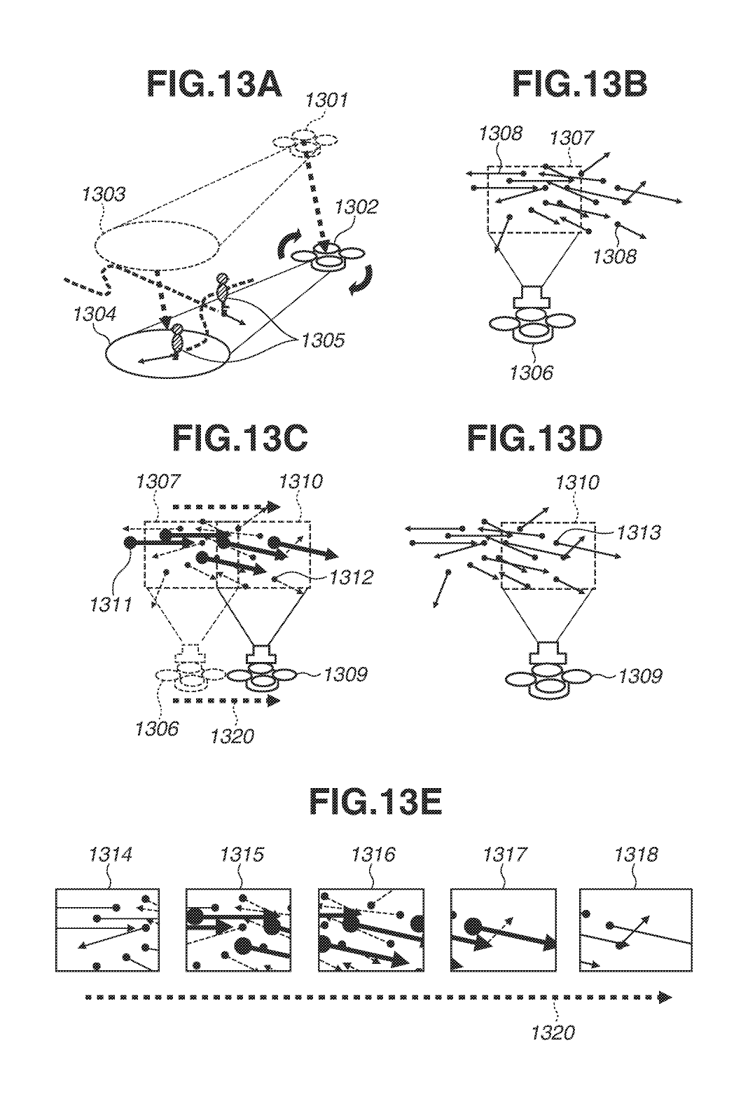

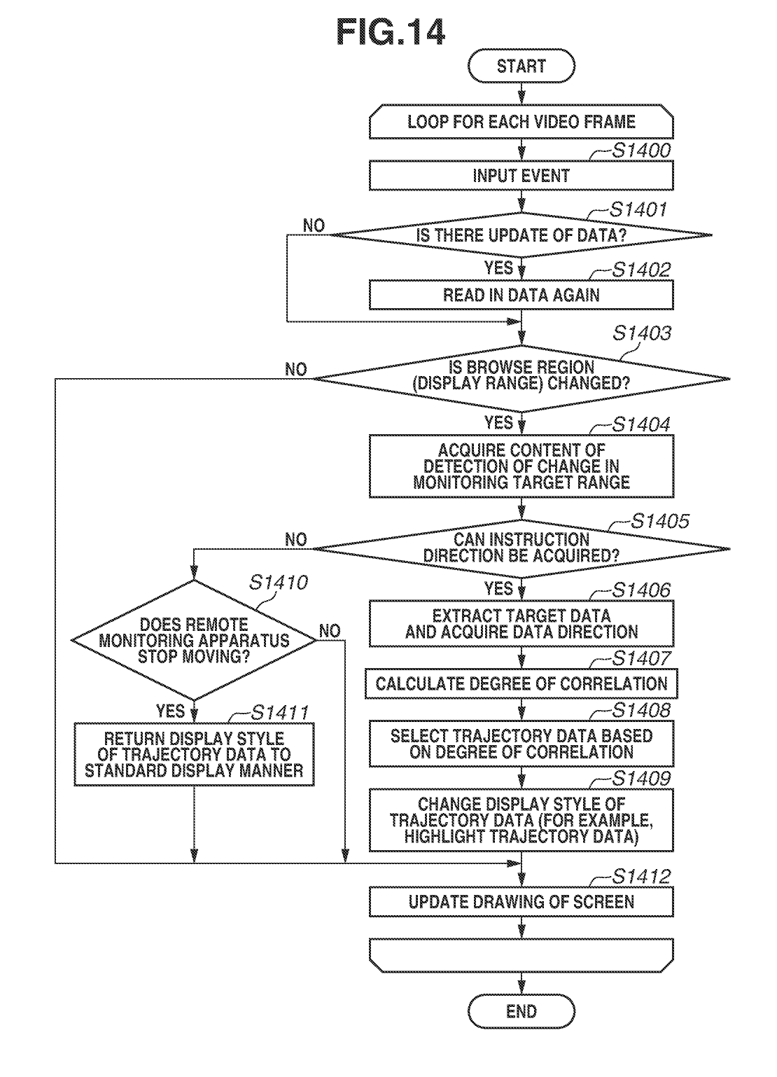

A configuration and an example operation of the data browse apparatus 100 according to the present exemplary embodiment will be described with reference to FIG. 12, FIGS. 13A, 13B, 13C, 13D, and 13E, and FIG. 14. The present exemplary embodiment will be described, omitting descriptions of similar configurations, functions, and operations to those of the first exemplary embodiment, and mainly focusing on differences from the first exemplary embodiment.

FIG. 12 illustrates an overview of a monitoring system including the data browse apparatus 100 according to the present exemplary embodiment. As differences from FIG. 2, the monitoring system illustrated in FIG. 12 includes a remote monitoring apparatus 1201 and a remote operation unit 1202. The remote monitoring apparatus 1201 includes a monitoring camera unit (an imaging unit) that acquires image data for displaying the data on the display unit 102. Further, the remote monitoring apparatus 1201 is an unmanned airplane that images the monitoring space 201 from the air, including a driving unit that realizes control of a posture in the air, driving in the air, and a self-propelled movement.

The remote monitoring apparatus 1201 can monitor a monitoring target (for example, the pedestrians 202) by hovering in the air or moving in the air. The image data captured by the monitoring camera unit is transferred to the monitoring server apparatus 204 via wireless communications or the like. The remote operation unit 1202 operates a movement of the remote monitoring apparatus 1201 (a forward/backward/leftward/rightward movement, a change in a direction, and an upward/downward movement), and operates an orientation, an angle of view, and the like of the monitoring camera unit. The remote operation unit 1202 receives these operations performed by the surveillant 206, and transmits them to the remote monitoring apparatus 1201.

The data browse apparatus 100 acquires the image data captured by the monitoring camera apparatus 203 or the remote monitoring apparatus 1201, and acquires the trajectory data indicating the orientation of the monitoring target (the pedestrian 202) as the spatial data (the browse data). The trajectory data (the line data) of the monitoring target or moving point data (the point data) indicating a current position is displayed on the display unit 102 while being superimposed on the image data. The data that is set as the monitoring target, and the space of the data are similar to those in FIG. 3, and FIGS. 4A, 4B, and 4C.

FIGS. 13A, 13B, 13C, 13D, and 13E illustrate the imaging by the unmanned airplane. FIG. 14 is a flowchart illustrating the operation of the data browse apparatus 100 according to the present exemplary embodiment.

As illustrated in FIG. 13A, the remote monitoring apparatus 1201 images the monitoring space 201 while moving in the air over the monitoring space 201. The monitoring target (a pedestrian 1305) is walking in the monitoring space 201. In the present exemplary embodiment, steps S1401 to S1412 illustrated in FIG. 14 are performed for each frame of the captured image data. First, in step S1401, the data update unit 151 checks whether there is an update of the data (the trajectory data or the like) displayed on the display unit 102.

If the data update unit 151 detects an update of the data (YES in step S1401), the processing proceeds to step S1402, in which the data update unit 151 reads in the data again. Then, the processing proceeds to step S1403. If the data update unit 151 detects no update of the data (NO in step S1401), the processing proceeds to step S1403. In step S1403, the instruction execution unit 152 functions as the display range movement unit, and determines whether the browse region (the display range) is changed.

The change in the browse region means a change in a visual field, a change in an imaging range, and a change in the angle of view, which would be caused due to a movement or the like of the imaging unit of the monitoring camera apparatus 203, the remote monitoring apparatus 1201, or the like.

In FIG. 13A, the remote monitoring apparatus 1201 moves from a monitoring position 1301 to a monitoring position 1302 according to an instruction issued from the surveillant 206 or an autonomous movement. In this case, the imaging range imaged by the monitoring camera unit (the imaging unit) of the remote monitoring apparatus 1201 is moved from an imaging range 1303 to an imaging range 1304. This movement causes a change in the display range displayed on the display unit 102. In step S1403, the instruction execution unit (the display range movement unit) 152 detects a change in the image data due to this change in the browse region (the display range).

As a method for detecting the change in the image data, the instruction execution unit 152 may detect the change by using pattern matching of a background, or by collaborating with the monitoring server apparatus 204 to use absolute coordinates of the remote monitoring apparatus 1201 and a posture of the remote monitoring apparatus 1201 in the monitoring space 201. In addition thereto, the instruction execution unit 152 may detect the change in the image data by using a movement amount of the remote monitoring apparatus 1201 in the monitoring space 201, if information indicating the movement (a position, a rotation, an angle, an angular speed, an orientation, and the like) of the remote monitoring apparatus 1201 can be acquired from the monitoring server apparatus 204.

In the present example, the instruction execution unit 152 is assumed to detect the change in the browse region (the display range) based on a relative position between a fixed object, such as the background, and the remote monitoring apparatus 1201, and the present example does not take into consideration a relative position, a relative speed, and the like between the trajectory data displayed while being superimposed on the image data, and the remote monitoring apparatus 1201. At this time, if the change in the browse region (the display range) is detected (YES in step S1403), the processing proceeds to step S1404. If the change in the browse region (the display range) is not detected (NO in step S1403), the processing proceeds to step S1412.

In step S1404, the instruction execution unit (the instruction direction acquisition unit) 152 acquires a movement amount or a change amount of the browse region (the display range). FIGS. 13B and 13C illustrate an example in which the browse region (the display range) is changed due to the movement of the remote monitoring apparatus 1201.

As illustrated in FIG. 13B, at a position 1306 of the remote monitoring apparatus 1201, the monitoring camera unit (the imaging unit) images an imaging range 1307, and displays moving point data 1308 located in the monitoring space 201 on the display unit 102 while superimposing the moving point data 1308 on the image data. At this time, as illustrated in FIG. 13C, the monitoring camera unit images the imaging range while moving the imaging range from the imaging range 1307 to an imaging range 1310 according to a movement of the remote monitoring apparatus 1201 from the position 1306 to a position 1309.

The movement amount or the change amount of the browse region (the display range) is quantified by execution of the pattern matching or the like for each frame with respect to the image data acquired continuously according to the movement of the imaging unit in this manner.

In step S1405, the instruction execution unit (the instruction direction acquisition unit) 152 determines whether the instruction direction can be acquired based on a directional component of the change in the browse region by using the change in the browse region and a result of the quantification of the movement amount or the change amount.

The directional component refers to a direction of the change in the image data and the movement amount thereof that would be caused by the movement of the monitoring camera unit or a rotation of a camera axis. The movement amount is determined based on, for example, the number of pixels by which the image data is changed that is detected by the pattern matching or the like. If the directional component is acquired from the change in the image data (YES in step S1405), the instruction execution unit (the instruction direction acquisition unit) 152 acquires the instruction direction based on a movement direction of the monitoring camera unit (the imaging unit). Then, the processing proceeds to step S1406.

Processing from steps S1406 to S1409 is processing in which the “input vector data” in the first exemplary embodiment is replaced with the “instruction direction based on the movement direction of the imaging unit”, and corresponds to the processing of steps S707 to S710.

Adding a supplementary description, in step S1406, the target data extraction unit (the data direction acquisition unit) 153 extracts the target data, and acquires the data direction. In step S1407, the degree-of-correlation acquisition unit 154 calculates the degree of correlation with the instruction direction based on the movement direction of the imaging unit, with respect to the trajectory data that is the target data. In steps S1408 and S1409, the display change unit 156 changes the display style regarding the data having the predetermined degree of correlation.

As illustrated in FIG. 13C, while the remote monitoring apparatus 1201 is moving, a movement direction 1320 of the remote monitoring apparatus 1201 is acquired as the instruction direction, and trajectory data 1311 is highlighted but trajectory data 1312 is not highlighted based on the degree of correlation between the data direction and the instruction direction. The data browse apparatus 100 changes the display style regarding the data having the predetermined degree of correlation based on the movement direction of the imaging unit in this manner, and thereby can improve the visibility of the desired data.

If the directional component is not acquired from the change in the image data in step S1405 (NO in step S1405), the processing proceeds to step S1410. In step S1410, whether the remote monitoring apparatus 1201 stops moving is detected. If the remote monitoring apparatus 1201 stops moving (YES in step S1410), the processing proceeds to step S1411, in which the display unit 102 returns the display style of the trajectory data to the standard display style.

FIG. 13D illustrates that the highlighted display of the data is ended and is returned to the standard display style according to the stop of the movement of the remote monitoring apparatus 1201. As illustrated in FIG. 13D, moving point data 1313 is displayed back in the standard display style.

If the remote monitoring apparatus 1201 does not stop moving in step S1410 (NO in step S1410), the processing proceeds to step S1412. In step S1412, the display unit 102 changes the drawing of the screen based on the processing of steps S1401 to S1411.

The above-described loop processing is continuously performed on a large number of frames of the image data captured by the imaging unit. FIG. 13E illustrates examples of browse regions acquired by continuously performing the above-described processing. As illustrated in FIG. 13E, browse regions (display ranges) 1314 to 1318 are browse regions imaged along the movement direction 1320 of the remote monitoring apparatus 1201 from the position 1306 to the position 1309.

In the browse regions (the display ranges) 1314 and 1318, the highlighted display of the trajectory data is ended because the remote monitoring apparatus 1201 stops moving. On the other hand, in the browse regions (the display ranges) 1315 to 1317, the trajectory data having the high degree of correlation is highlighted with the movement direction 1320 of the remote monitoring apparatus 1201 set as the instruction direction, because the remote monitoring apparatus 1201 is moving.

The data in the present exemplary embodiment is the point data expressed by the current position and the orientation (the position direction) of the monitoring target (the pedestrian 202). The position direction of the point data refers to a direction at the position of the point data. For example, an orientation of a face or a body of the pedestrian 202 at the current position of the pedestrian 202 that is the point data is used as the data direction. Further, the present exemplary embodiment can also be achieved with use of the trajectory data indicating a movement trail of the monitoring target.

In this manner, the present exemplary embodiment has been described, referring to the example in which the display style regarding the data is changed based on the movement direction of the imaging unit that carries out remote monitoring. With this configuration, the data browse apparatus 100 can prevent the surveillant 206 from losing track of the pedestrian 202 that is the monitoring target when there are a large number of pedestrians 202 in the monitoring region.

Even when the imaging unit images a different direction from the movement direction of the remote monitoring apparatus 1201, if the imaging unit images the monitoring target while tracking the monitoring target, the direction of this tracking is set as the instruction direction, so that the data browse apparatus 100 can highlight the trajectory data that is the monitoring target. With this configuration, the data browse apparatus 100 can improve the visibility of the trajectory data having the high degree of correlation with the tracking direction of the imaging unit (the instruction direction), thereby preventing the surveillant 206 from losing track of the pedestrian 202 that is the monitoring target when there are a large number of pedestrians 202 in the monitoring region.

The present exemplary embodiment has been described referring to the example in which the trajectory data is updated in real time, but the present exemplary embodiment can also be applied to the trajectory data acquired in the past. Further, the present exemplary embodiment has been described referring to the example in which the absolute coordinates are used by collaborating with the monitoring server apparatus 204, but the change in the image data may be detected with use of the relative speed between the imaging unit and the monitoring target.

Further, a plurality of directional components may be acquired. For example, if the imaging unit is rotated, the direction of the directional component is the same between observation points located at same angles with respect to the rotational axis, but the direction of the directional component is different between observation points located at different angles with respect to the rotational axis. Further, if the imaging unit is rotated, the movement amount of the directional component is the same between observation points located at same distances from the rotational axis, but the movement amount of the directional component is different between observation points located at different distances from the rotational axis.

Further, if the imaging unit zooms in or zooms out, the browse region (the display range) is enlarged or reduced, so that a direction radiating from a center of the enlargement or the reduction or an opposite direction therefrom is acquired as the direction of the directional component. Further, if the imaging unit zooms in or zooms out, the movement amount of the directional component is the same between observation points located at same distances from the center of the enlargement or the reduction, but the movement amount of the directional component is different between observation points located at different distances from the center of the enlargement or the reduction.

In such a case, the browse region (the display range) may be divided into a plurality of regions, and then the directional component (the instruction direction) may be acquired for each of the regions.

Other than those, it is also effective to use a direction in which the observation point is changed if the browse region (the display range) is changed due to switching of the browse region (the display range), folding or unfolding of the remote monitoring apparatus 1201 itself, and the like.

In this manner, the instruction execution unit (the instruction direction acquisition unit) 152 may acquire the direction of the change in the data (for example, the observation point) due to at least one of the rotation, the enlargement, the reduction, and the switching of the display on the display unit 102 as the directional component (the instruction direction).

With this configuration, the data browse apparatus 100 can acquire the directional component (the instruction direction) corresponding to various changes in the browse region (the display range) based on the movement direction of the imaging unit, thereby providing an effect of improving the visibility of the data and preventing the surveillant 206 from losing track of the desired data that the surveillant 206 has been tracking.

The present exemplary embodiment has been described referring to the example that uses the trajectory data, but can also be applied to map data having the directional component. Further, the present exemplary embodiment has been described referring to the example in which the present exemplary embodiment is applied to the remote monitoring apparatus, but can also be applied to a data browse apparatus using, for example, a wearable device, a head-mounted display (HMD), a tablet device, and another type of mobile terminal that can move by an autonomous movement or a remote operation and include the imaging unit.

For example, the present exemplary embodiment can also be applied to a surgery aid apparatus for use in an endoscopic surgery or the like. The data browse apparatus (the user interface) in this case is assumed to display a group of blood vessels of a patient (a line data group) and image data captured by an endoscope. In this case, the data browse apparatus highlights a blood vessel having a high degree of correlation (for example, an absolute value of a cosine value) between a direction of the blood vessel (the data direction) and a movement direction of the endoscope (the instruction direction), thereby providing an effect of improving the visibility of the blood vessel and aiding observation with use of the endoscope.

A fifth exemplary embodiment will be described as an example in which the degree of correlation between the instruction direction recorded per predetermined time period and the data direction is calculated.

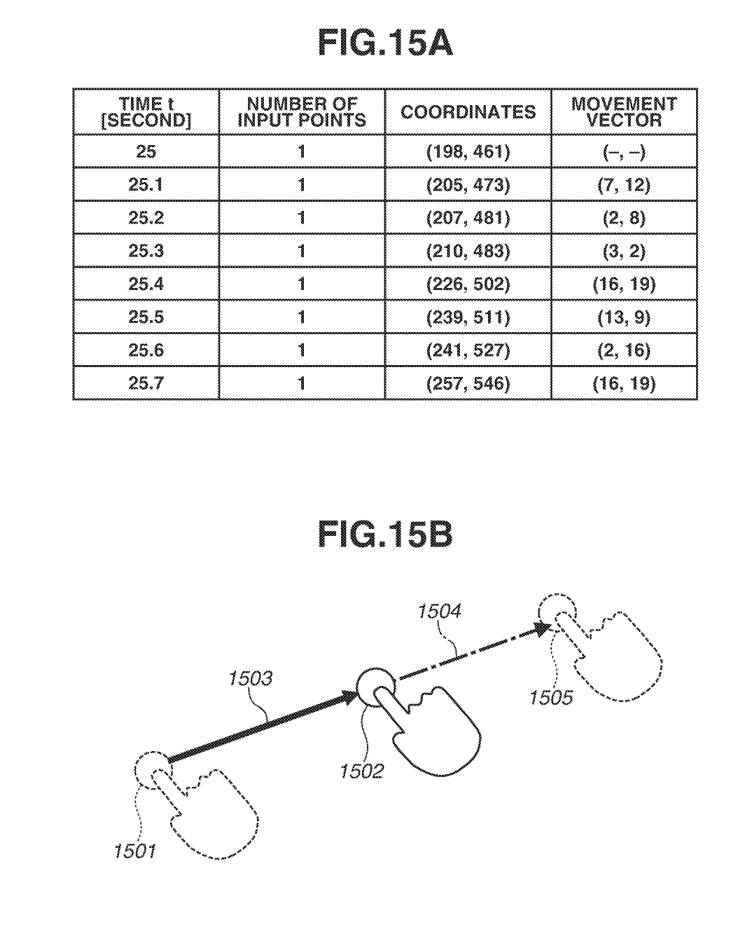

The data browse apparatus 100 according to the present exemplary embodiment includes similar components to the data browse apparatus 100 according to the first exemplary embodiment. An example of an operation of the data browse apparatus 100 according to the present exemplary embodiment will be described with reference to FIGS. 15A and 15B. The present exemplary embodiment will be described, omitting descriptions of similar configurations, functions, and operations to those of the first exemplary embodiment, and mainly focusing on differences from the first exemplary embodiment.

The storage unit 109 illustrated in FIG. 1 functions as an instruction direction recording unit, and records a history (at least one of the acquisition position, the direction, and the length) of the operation instruction (the instruction direction) acquired by the instruction execution unit (the instruction direction acquisition unit) 152 per predetermined time period.

In step S706 illustrated in FIG. 7A, the instruction execution unit 152 determines whether the operation instruction is an instruction to start or continue scrolling the image. If the operation instruction is the instruction to start or continue scrolling the image (YES in step S706), the storage unit (the instruction direction recording unit) 109 records the history of the scroll direction (the instruction direction) of the browse region (the display range) per predetermined time period, and then the processing proceeds to step S707.

FIG. 15A illustrates an example of the history of the instruction direction recorded by the storage unit (the instruction direction recording unit) 109. As illustrated in FIG. 15A, the number of input points, coordinates (the acquisition position), and a movement vector (the direction and the length) of the input point are recorded per predetermined time period (every 0.1 seconds). The movement vector of the input point is a movement vector defined by the movement of the input point during the predetermined time period, and corresponds to the input vector data (the instruction direction) per predetermined time period.

As illustrated in FIG. 15B, a movement vector 1503 from an input point 1501 to an input point 1502 is recorded. In the present exemplary embodiment, the movement vector is recorded every 0.1 seconds, but the movement vector may be recorded at an event detection interval, or may be recorded at such a time interval that a distance of the movement vector reaches a predetermined distance. In this manner, the time interval at which the instruction direction is recorded may be changed according to the intended purpose.

Then, after the history of the instruction direction is recorded, in step S708, the degree-of-correlation acquisition unit 154 calculates the degree of correlation between the scroll direction (the instruction direction) recorded per predetermined time period, and the data direction.

For example, the instruction execution unit (the instruction direction acquisition unit) 152 derives a virtual input point 1505 after acquiring a virtual movement vector 1504 that would be defined when the input point is moved by a predetermined distance in an extension direction of the movement vector 1503. The degree-of-correlation acquisition unit 154 calculates the degree of correlation of the data while setting a direction of the movement vector 1504 as the instruction direction. Further, the instruction execution unit (the display range movement unit) 152 may move the display range of the display unit 102 along the movement vector 1504. This processing causes the data to be highlighted according to the history of the operation instruction.

Further, examples of calculating the degree of correlation with use of the coordinates of the history of the operation instruction also include the following method. The target data extraction unit (the data direction acquisition unit) 153 selects two observation points located near the coordinates (the acquisition position) of the input point with respect to each piece of trajectory data. Then, the degree-of-correlation acquisition unit 154 calculates the degree of correlation between a line segment connecting these two points and the movement vector, and performs the processing for calculating the degree of correlation at a plurality of times. Then, the degree-of-correlation acquisition unit 154 outputs a sum or an average of the degrees of correlation respectively corresponding to the individual times as a final degree of correlation.

With this configuration, the data browse apparatus 100 can quantify the degree of correlation between a trail of the input point that is indicated by the recorded history, and the data. Therefore, the data is highlighted according to the history of the operation instruction.

A sixth exemplary embodiment will be described as an example in which the degree of correlation is weighted according to the acquired data or instruction direction.

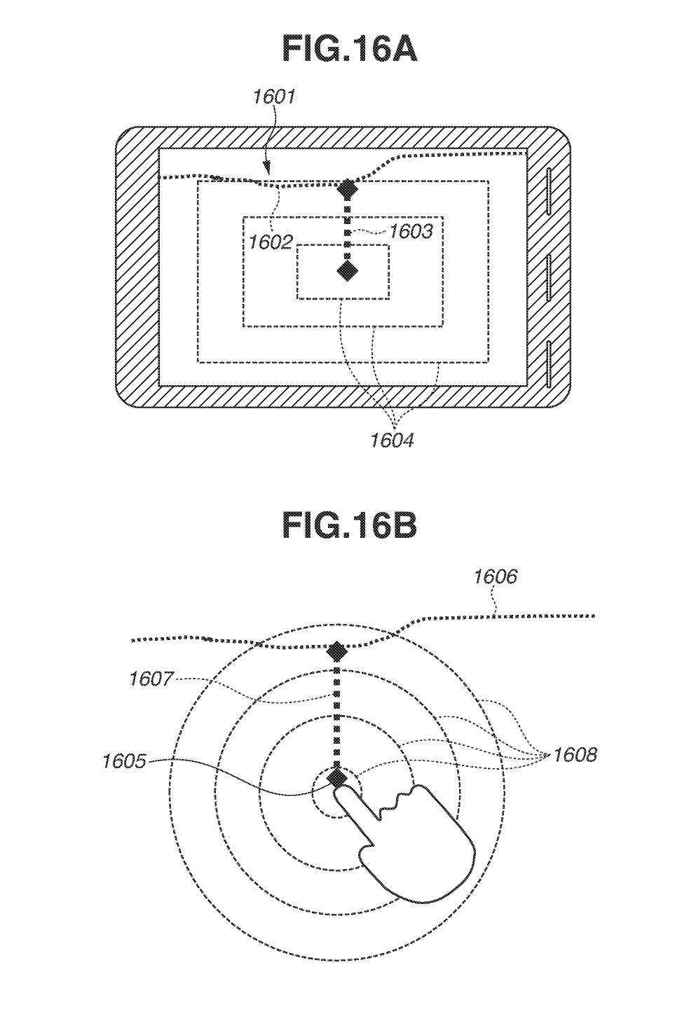

The data browse apparatus 100 according to the present exemplary embodiment includes similar components to the data browse apparatus 100 according to the first exemplary embodiment. An example of an operation of the data browse apparatus 100 according to the present exemplary embodiment will be described with reference to FIGS. 16A and 16B. The present exemplary embodiment will be described, omitting descriptions of similar configurations, functions, and operations to those of the first exemplary embodiment, and mainly focusing on differences from the first exemplary embodiment.

The degree-of-correlation acquisition unit 154 weights the degree of correlation according to the acquisition position of at least one of the data and the instruction direction.

In step S707 illustrated in FIG. 7A, the target data extraction unit (the data direction acquisition unit) 153 extracts the target data, and acquires the data direction of the target data. In step S708, the degree-of-correlation acquisition unit 154 calculates the degree of correlation between the data direction of the trajectory data that is the target data, and the instruction direction, and weights the degree of correlation for each piece of trajectory data.

A weighting coefficient is determined based on the acquisition position of the data. For example, as illustrated in FIG. 16A, the weighting coefficient may be determined according to weighting coefficient sections 1604 classified into stages according to a distance 1603 from a center of the screen to trajectory data 1602 in a browse region (a display range) 1601. Through this weighting, the degree of correlation of the trajectory data 1602 is weighted according to the acquisition position of the data.

Further, as illustrated in FIG. 16B, the weighting coefficient may be determined according to weighting coefficient sections 1608 classified into stages according to a distance 1607 from an input point 1605 where the instruction direction is input to trajectory data 1606. Through this weighting, the degree of correlation of the trajectory data 1606 is weighted according to the acquisition position of the instruction direction.

In either case, the sections 1604 and 1608 are set in such a manner that the weighting coefficient increases as the position is located closer to the center of the screen or the input point, and reduces as the position is located farther away from the center of the screen or the input point. For example, the weighting coefficient is determined by an expression (1).

(weighting coefficient)=1.0−(distance expressed by the number of pixels)×0.001 (1)

As a result, the degree of correlation is set to a higher value for the trajectory data located closer to the center of the screen or the input point. Through the above-described processing, the data browse apparatus 100 can further emphatically display the data that the surveillant 206 pays attention to because the trajectory data that the surveillant 206 pays attention to is considered to be located near the center of the screen or the input point.

Further, the number of observation points of the trajectory data that are contained in the browse region (the display range) may be counted, and the weighting coefficient may be determined in such a manner that the degree of correlation of this trajectory data increases as the number of observation points less changes according to the scroll. For example, the weighting coefficient is determined by the following expression, an expression (2).

(weighting coefficient)=100−|(the number of observation points before the scroll)−(the number of observation points after the scroll)| (2)

Further, a specific point of the trajectory data may be determined as to whether this point can be observed in the browse region (the display range) before the scroll and after the scroll, and the weighting coefficient may be determined in such a manner that the degree of correlation of this trajectory data increases if the specific point can be observed. Further, the number of times that a specific point of the trajectory data is displayed in the browse region (the display range) may be counted for each operation instruction requesting the scroll, and the weighting coefficient may be determined in such a manner that the degree of correlation of this trajectory data increases as the number of times increases. As a result, the weighting coefficient increases for the trajectory data that stays in the browse region (the display range) for a long time, which allows the data browse apparatus 100 to change the display style of the desired trajectory data that the surveillant 206 is tracing.

A seventh exemplary embodiment will be described as an example in which the instruction direction is predicted by calculating the degree of correlation of data located outside the display range of the display unit 102.

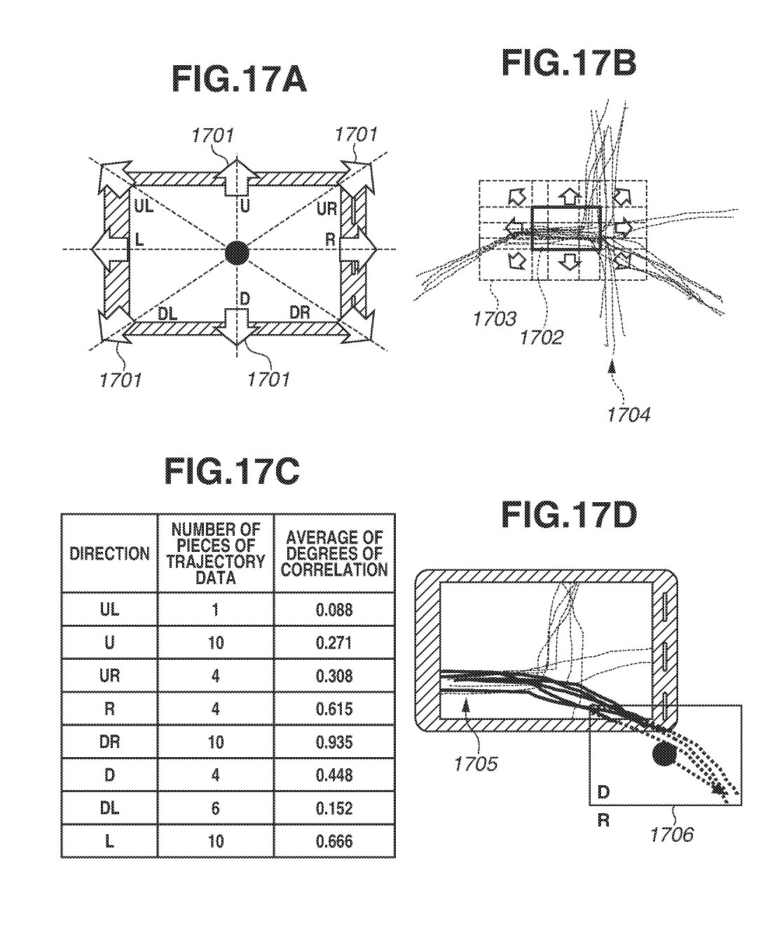

The data browse apparatus 100 according to the present exemplary embodiment includes similar components to the data browse apparatus 100 according to the first exemplary embodiment. An example of an operation of the data browse apparatus 100 according to the present exemplary embodiment will be described with reference to FIGS. 17A, 17B, 17C, and 17D. The present exemplary embodiment will be described, omitting descriptions of similar configurations, functions, and operations to those of the first exemplary embodiment, and mainly focusing on differences from the first exemplary embodiment.

The instruction execution unit 152 functions as a direction setting unit, and sets a direction from the browse region (the display range) of the display unit 102 to an outside of the browse region (the display range). The target data extraction unit (the data direction acquisition unit) 153 acquires the data direction outside the browse region (the display range) of the display unit 102. The instruction execution unit 152 functions as the instruction direction acquisition unit, and acquires the set direction as the instruction direction. The degree-of-correlation acquisition unit 154 calculates the degree of correlation between the data direction outside the browse region (the display range) of the display unit 102 and the set direction (the instruction direction).

In step S704 illustrated in FIG. 7, the instruction execution unit 152 sets the direction toward the outside of the browse region (the display range), and acquires the set direction as the instruction direction.

In step S706, the instruction execution unit 152 determines whether the operation instruction starts scrolling the image or is currently scrolling the image, and determines whether the data browse apparatus 100 is set in a mode of predicting the instruction direction along therewith. If the operation instruction is the instruction to start or continue scrolling the image, or if the data browse apparatus 100 is set in the mode of predicting the instruction direction (YES in step S706), the processing proceeds to step S707. In step S707, the target data extraction unit (the data direction acquisition unit) 153 acquires the data direction outside the browse region (the display range).

In step S708, the degree-of-correlation acquisition unit 154 calculates the degree of correlation between the data direction outside the browse region (the display range) and the set direction (the instruction direction).

As illustrated in FIG. 17A, the instruction execution unit 152 sets each of eight directions (an upward direction U, a downward direction D, a leftward direction L, a rightward direction R, an upper left direction UL, an upper right direction UR, a lower right direction DR, and a lower left direction DL) 1701 as the direction toward the outside of the browse region (the display range), and acquires each of the set directions as the instruction direction. As illustrated in FIG. 17B, the degree-of-correlation acquisition unit 154 calculates the degree of correlation between the data direction of the trajectory data and the instruction direction with respect to each of ranges 1703 that are defined by shifting a browse region 1702 in the eight directions 1701, respectively.

The eight directions 1701 are set so as to form an angle of 45 degrees between every two adjacent directions, and the browse region 1702 and each of the ranges 1703 have an portion of 30% that overlaps each other. These angle and rate of the overlapping portion are arbitrarily set.

FIG. 17C illustrates an example of calculating an average of the degrees of correlation with respect to each of the ranges 1703 that are shifted in the eight directions 1701, respectively.

In step S709, the display change unit 156 selects the range 1703 having a highest degree of correlation based on the number of pieces of trajectory data and a statistical value of the degrees of correlation. Examples of the statistical value of the degrees of correlation include a sum, an average, a median value, a maximum value, a minimum value, a dispersion, a standard deviation, a frequency, and the like of the degrees of correlation.

For example, in FIG. 17C, the average of the degrees of correlation with respect to the lower right direction DR indicates a maximum value (0.935). In FIG. 17B, the browse region 1702 is not moved in any direction because this browse region is the browse region before the scroll. In this case, the instruction direction is predicted by the calculation of the degree of correlation of the data located outside the browse region 1702 (the trajectory data in the range 1703).

In other words, the lower right direction DR is set as the instruction direction. Then, as illustrated in FIG. 17D, the degrees of correlation between data directions in browse regions 1705 and 1706 and the lower right direction DR are calculated, and in steps S710 and S713, the trajectory data is highlighted according to the degree of correlation.

Through this processing, the data browse apparatus 100 calculates the degree of correlation of the data located outside the browse region (the display range) and sets the direction with respect to which the average of the degrees of correlation is maximized as the instruction direction, and thereby can highlight the direction in which many pieces of trajectory data flow among the individual directions. As a result, the surveillant 206 can efficiently understand the flow of the trajectory data.

Other than that, the data browse apparatus 100 may change the highlighted display of the data in the browse region by analyzing the data. For example, if there are a large number of pieces of data (a large number of pieces of trajectory data) despite a low degree of correlation, it is possible that a branch of the data may occur at a position along this direction. Therefore, the data browse apparatus 100 analyzes whether there is a branch with use of a method such as trajectory clustering, and groups the data by branch if there is a branch to then adopt a different display format for each group. In this way, the surveillant 206 can observe how the data flows before the branch in advance while being aware of the presence of the branch of the data.

Further, the present exemplary embodiment has been described, referring to the example in which the display style of the data is changed based on the degree of correlation of the data located outside the browse region (the display range). However, the instruction execution unit (the display range movement unit) 152 may move the browse region (the display range) along the scroll direction while setting the instruction direction as the scroll direction. For example, as illustrated in FIG. 17D, the trajectory data in the browse regions 1705 and 1706 may be highlighted while the browse region (the display range) 1705 is moved in the lower right direction DR.

Further, the instruction execution unit (the display range movement unit) 152 may increase/decrease the scroll speed or stop the scroll, like step S1110 in the third exemplary embodiment.

In this manner, the data browse apparatus 100 predicts the direction that would become the instruction direction among the set directions without the surveillant 206 performing an operation and changes the display style of the data, and therefore can aid the observation of the surveillant 206.

An eighth exemplary embodiment will be described as an example of solid fabrication data in 3D scanned data or the like. Generally, a noise shaped as a protrusion or a dent may occur on a plane in the data acquired by a 3D scanner. It is desired to correct this noise in view of a quality of the data, but each object to be scanned has a different shape, which requires a person knowing the accurate shape of the object to correct this noise by inspecting it with the user's own eyes.

This correction task is such a task that, with the data displayed in the browse region (the display range), an operator checks whether there is the noise by inspecting it with the user's own eyes while tracing the plane forming the solid fabrication object, and then corrects the noise. However, this task involves a risk of overlooking the noise since the noise check relies on the inspection with human eyes. For example, the operator cannot discover a tiny protrusion or dent (the noise) unless the browse region is enlarged, and also has to engage in the browse task turned into an excessive load, which make it difficult to accomplish the correction task.

Further, occurrence of an enlargement of the browse region, a rotation of the object, a movement of a viewpoint, a rotation of the viewpoint, and the like during the browse task makes it difficult for human vision to follow the movement to thereby reduce the visibility if a surface of the object displayed in the browse region is moved at a high speed. Further, if the noise is located on a rotational axis or an angle of the noise is small when viewed from the viewpoint, the rotation of the object and the rotation of the viewpoint may cause the operator to overlook the noise due to difficulty in distinguishing the noise from a neighborhood thereof and a low resolution.

Further, if a portion where the noise is displayed is located at an edge of the browse region or in the vicinity thereof, the operator may also overlook the noise.

To solve such problems, the eighth exemplary embodiment will be described as the example in which the display style of the object surface is changed in the browse region (the display range).

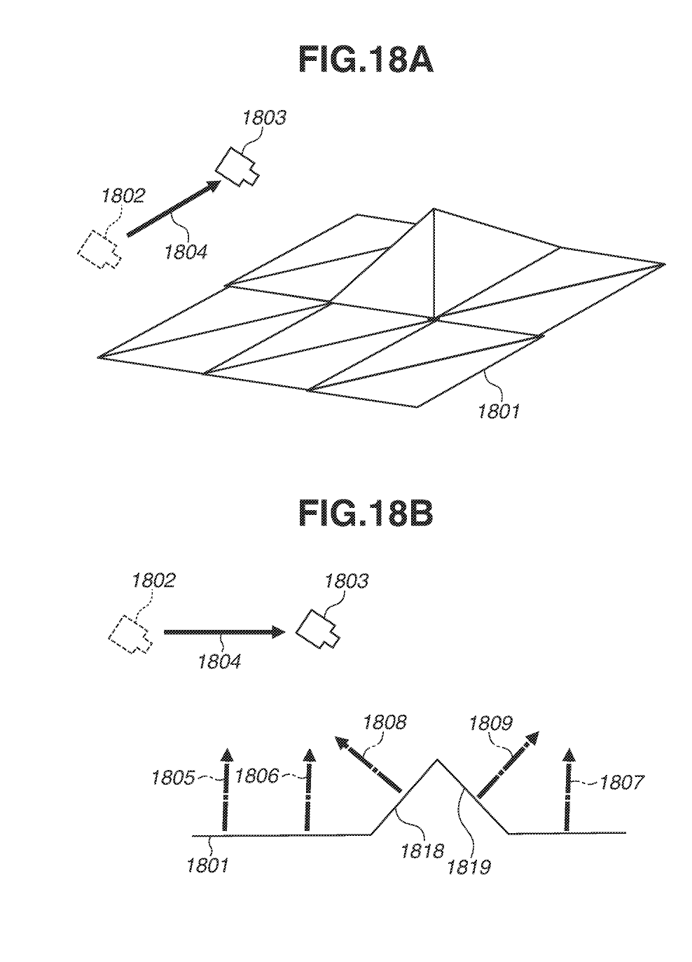

The data browse apparatus 100 according to the present exemplary embodiment includes similar components to the data browse apparatus 100 according to the first exemplary embodiment. An example of an operation of the data browse apparatus 100 according to the present exemplary embodiment will be described with reference to FIGS. 18A and 18B. The present exemplary embodiment will be described, omitting descriptions of similar configurations, functions, and operations to those of the first exemplary embodiment, and mainly focusing on differences from the first exemplary embodiment.

An object 1801, which is set as a target displayed in the browse region (the display range), is data (the 3D scanned data) including points, lines, and planes in a three-dimensional space that is acquired by the 3D scanner or the like.

In step S704 illustrated in FIG. 7A, the instruction execution unit 152 performs the processing for acquiring the operation instruction. Examples of the operation instruction include a movement of the object 1801, a rotation of the object 1801, an enlargement/reduction of the object 1801, a movement of a viewpoint 1802 or 1803, a rotation of the viewpoint 1802 or 1803, and a change in an angle of view of the viewpoint 1802 or 1803. Further, the examples of the operation instruction include a movement, a rotation, illuminance, and a diffusion angle of a light source or the like.

Further, the instruction execution unit 152 functions as the instruction direction acquisition unit, and acquires the instruction direction based on the operation instruction. For example, as illustrated in FIGS. 18A and 18B, the instruction execution unit (the instruction direction acquisition unit) 152 acquires a movement vector 1804 from the viewpoint 1802 to the viewpoint 1803 as the instruction direction. In addition thereto, the instruction execution unit (the instruction direction acquisition unit) 152 may calculate a movement vector in the three-dimensional space with respect to a midpoint of a plane forming the object 1801, and acquire the movement vector as the instruction direction. Thus, the instruction direction is acquired even with respect to the rotation of the object 1801 or the viewpoint 1802 or 1803.

In step S705, the instruction execution unit 152 executes the operation instruction according to the operation instruction. For example, the instruction execution unit 152 functions as the display range movement unit, and moves (scrolls) the browse region (the display range) of the display unit 102 along the movement vector (the instruction direction) 1804. This results in a change in a display position of the object 1801 in the browse region.

In step S706, the instruction execution unit 152 determines whether the operation instruction is an instruction to start or continue scrolling the image. If the operation instruction is the instruction to start or continue scrolling the image (YES in step S706), the processing proceeds to step S707.

In step S707, the target data extraction unit 153 extracts plane data among pieces of data (the point data, the line data, and the plane data) displayed in the browse region (the display range), as the target data. At this time, plane data contained in the browse region and plane data located near the browse region are extracted as the target data.

The target data extraction unit 153 can determine whether to extract plane data hidden as viewed from the viewpoint 1802 or 1803 by making this determination according to a distance from the viewpoint 1802 or 1803. For example, the target data extraction unit 153 extracts hidden plane data located within a distance that is twice as long as plane data located at a shortest distance from the viewpoint 1802 or 1803.

In step S708, the degree-of-correlation acquisition unit 154 calculates the degree of correlation with the movement vector (the instruction direction) 1804 with respect to the plane data that is the target data. For example, the degree-of-correlation acquisition unit 154 calculates normal vectors 1805 to 1809 of the plane data (polygon by polygon), and calculates an absolute value of a cosine value between each of the normal vectors 1805 to 1809 and the movement vector 1804 as the degree of correlation.

Since the normal vectors 1805 to 1807 are substantially perpendicular to the movement vector 1804, the degree of correlation (the absolute value of the cosine value) is close to zero. On the other hand, as the normal vector is becoming more parallel with the movement vector 1804, the degree of correlation (the absolute value of the cosine value) increases, so that the degree of correlation of each of the normal vectors 1808 and 1809 exceeds the degree of correlation of each of the normal vectors 1805 to 1807.

In steps S709 and 710, the display change unit 156 selects data having a degree of correlation that is a predetermined threshold value (for example, 0.3) or higher, and changes the display style of the selected data. For example, the display change unit 156 selects plane data 1818 and plane data 1819 respectively having the normal vectors 1808 and 1809, and changes the display styles of the plane data 1818 and the plane data 1819.

In this case, the display change unit 156 changes the display styles of the plane data 1818 and the plane data 1819 by adding a color to the plane data 1818 and the plane data 1819 so as to make the plane data 1818 and the plane data 1819 discernible from the other plane data. Alternatively, the display change unit 156 may change the display styles of the plane data 1818 and the plane data 1819 by moving coordinates of points forming the plane data 1818 and the plane data 1819 along a surface normal vector or a vertex normal vector.

In step S713, the data processed by the above-described processing is drawn in the browse region.

The instruction execution unit 152 repeats the above-described processing every time the operation instruction is received, which allows the data browse apparatus 100 to temporarily highlight the protrusion or the dent such as the noise generated at the time of the scan, thereby improving the visibility. As a result, the data browse apparatus can prevent the surveillant 206 from overlooking the noise when carrying out the correction task by inspecting it with the user's own eyes.

The display change unit 156 may improve the visibility by maintaining the changed display style without returning the display style to the standard display style or changing the display style along with creating the transition effect, if necessary. Further, the present exemplary embodiment also provides an effect of improving the visibility of undulation of a solid shape at the time of browsing plane data such as a surface of a mountain or a valley on a solid topographic map, in addition to preventing the surveillant 206 from overlooking the noise. Further, the present exemplary embodiment can also be applied to point data and line data such as a vertex and a boundary of a solid shape, and provides an effect of improving the visibility of the data.

A ninth exemplary embodiment will be described as an example in which the data direction is acquired based on a position of point data on a map.

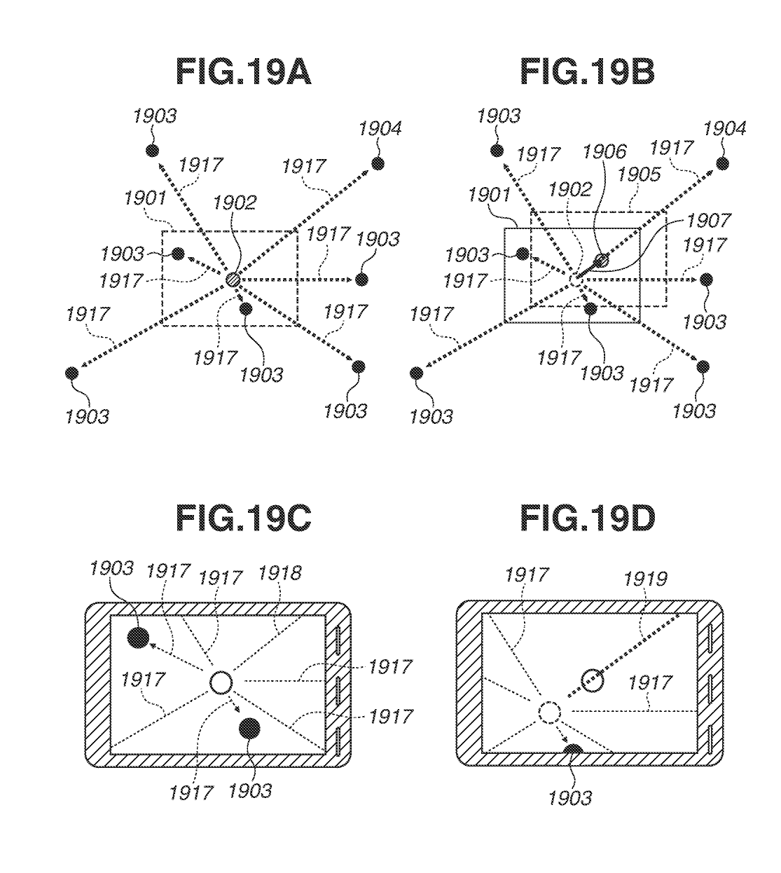

The data browse apparatus 100 according to the present exemplary embodiment includes similar components to those of the data browse apparatus 100 according to the first exemplary embodiment. An example of an operation of the data browse apparatus 100 according to the present exemplary embodiment will be described with reference to FIGS. 19A, 19B, 19C, and 19D. The present exemplary embodiment will be described, omitting descriptions of similar configurations, functions, and operations to those of the first exemplary embodiment, and mainly focusing on differences from the first exemplary embodiment.

The target data extraction unit (the data direction acquisition unit) 153 acquires at least one of a direction of a line segment between a predetermined reference point and point data and a direction of a line segment between two pieces of point data as the data direction. In this case, a destination point (the point data), such as a destination or a landmark including at least a single point, is provided as the point data.

In FIG. 19A, a browse region (a display range) 1901 is set in an arbitrary monitoring space, and the browse region (the display range) 1901 can be scrolled in an arbitrary direction. FIG. 19A illustrates this example assuming that an operator browses the browse region 1901 while understanding a path to a landmark (a destination point) 1904 registered to a map, a floor plan, or the like. A central point of the browse region 1901 is set as a reference point 1902. A destination point 1903 is located inside the browse region 1901. Further, a destination point 1903 is also located outside the browse region 1901.

With these destination points (the pieces of point data) 1903 and 1904 provided in the monitoring space, the operator performs the operation of scrolling the browse region (the display range) 1901. In FIG. 19B, a scroll direction (the instruction direction) directed in the upper right direction is input as the operation instruction. Then, in steps S704 and S705, the instruction execution unit (the display range movement unit) 152 moves the browse region 1901 of the display unit 102 to a browse region 1905 along the upper right direction (the instruction direction).

In step S708, a cosine value between vector data (the data direction) from the reference point 1902 to each of the target points 1903 and 1904 and the scroll direction (the instruction direction) is calculated as the degree of correlation.

For example, vector data 1907 from the reference point 1902 in the browse region 1901 before the scroll to a reference point 1906 in the browse region 1905 that is being scrolled is acquired as the instruction direction. Further, vector data 1917 from the reference point 1902 before the scroll to each of the destination points 1903 and 1904 is acquired as the data direction.

FIG. 19C illustrates an example of the browse region (the display range) before being scrolled in a direction toward the destination point 1904. The vector data 1917 and vector data 1918 toward the respective destination points 1903 and 1904 are displayed with the reference point 1902 placed at the center thereof. The vector data 1918 toward the destination point 1904 is displayed in the standard display style because this vector data is vector data before the scroll. As illustrated in FIG. 19B, upon an input of the operation instruction requesting the scroll, in steps S709 and 710, the data is selected based on the degree of correlation, and the display style is changed with respect to the selected data.

FIG. 19D illustrates an example of the browse region (the display range) that is being scrolled in the direction toward the destination point 1904. Vector data 1919 is highlighted based on the degree of correlation between the vector data (the data direction) 1919 between the reference point 1902 and the destination point 1904, and the vector data 1907 that is the scroll direction (the instruction direction).

Through this processing, when the browse region (the display range) is scrolled to a specific destination point, the data browse apparatus 100 can prevent a scroll operation deviating from the direction from the reference point toward the destination point. For example, if an operation of scrolling the browse region in a different direction from the direction toward the specific destination point is input, the data browse apparatus 100 scrolls the browse region by a shorter movement distance than a movement distance moved by a standard scroll operation, and thereby can make the operator feel strange to alert the operator. Further, the data browse apparatus 100 changes the display style of the path data until arrival at the specific destination point, and therefore can aid the operator until the arrival at the destination point. This is effective especially, for example, when the operator rapidly scrolls the browse region in a wide space.

In this manner, the present exemplary embodiment has been described, referring to the example in which the direction of the line segment between the pieces of point data indicating the two points (including the point data indicating the reference point 1902) is set as the data direction. The data browse apparatus 100 can also hide vector data having a degree of correlation that is a predetermined threshold value or lower, use a curved line instead of the straight line, or use a shortest path to the destination point on the map as the data direction, to improve the visibility.

Further, when complicated data is displayed in the display region, the data browse apparatus 100 can prevent or reduce a drastic or frequent change in the display style during the scroll by fixing the reference point for a predetermined time period, thereby further improving the visibility for the operator. Moreover, the data browse apparatus 100 can further improve the visibility for the operator by employing the transition effect using a graphics attribute, such as a transparency and a width, when changing the display style.

The reference point may be an arbitrary point located inside or outside the browse region (the display range), other than the central point of the browse region (the display range). For example, the reference point may be an arbitrary destination point specified by a tap operation or a click operation input on the touch panel. For example, when displaying a path from a station where the operator gets off a train to the destination point on a walk navigation system, the data browse apparatus 100 calculates the degree of correlation while setting the path connecting the pieces of data as the data direction after the station where the operator gets off the train and the destination point are specified, and thereby can improve the visibility for the operator on the walk navigation system.

Further, the instruction execution unit (the display range movement unit) 152 may increase/decrease the scroll speed, or stop the scroll, like in step S1110 in the third exemplary embodiment.

Further, if the point data specified as the destination point is not constituted by a single point but is constituted by a plurality of points, the data browse apparatus 100 can also use a point acquired by sampling the plurality of points or average coordinates of the plurality of points as the destination point.

Further, the present exemplary embodiment has been described referring to the example in which the data browse apparatus 100 is used together with the map, but the data browse apparatus 100 may be a browse apparatus including a user interface that displays icons or thumbnails of picture data in the browse region (the display range) while arranging them at least two-dimensionally. The present exemplary embodiment can be applied by treating an icon or a thumbnail as the destination point and the central point in the browse region (the display range) as the reference point. With this configuration, the browse apparatus can guide the scroll in a direction toward the icon or the thumbnail that is the destination.

Further, the present exemplary embodiment can also be applied to browsing a document file, such as a poster, a document, and a pamphlet, by treating coordinate values of an object, such as an image and a paragraph in the document file, as the destination point, and treating the central point in the browse region (the display range) as the reference point. With this configuration, the browse apparatus can guide the scroll in a direction toward the object that is the destination.

The exemplary embodiments of the present invention have been described above, but the present invention is not limited thereto, and can be changed or modified within a range recited in the claims.

The data stored in the storage unit 109 only has to be at least one of the point data, the line data, and the plane data. Further, at least one of the position direction of the point data, the line direction of the line data, and the normal direction of the plane data only has to be acquired as the data direction.

Data other than the point data, the line data, and the plane data may be displayed on the display unit 102. For example, a three-dimensional solid shape may be displayed on the display unit 102. In this case, a position of the solid shape or a point forming the solid shape is the point data. A movement direction of the solid shape or a line forming the solid shape is the line data. A plane forming the solid shape is the plane data. Further, a position of the plane and a point forming the plane are the point data, and a movement direction of the plane and a line forming the plane are the line data.

Further, in an exemplary embodiment of the present invention, at least one of the position direction of the point data, the line direction of the line data, and the normal direction of the plane data is acquired as the data direction. Examples of the data direction include a directional attribute value such as a direction of a person that is output by a human trajectory detection system, a direction derived from an arbitrary point of monitoring target data and a monitoring reference point, a direction acquired by connecting arbitrary points of a plurality of pieces of monitoring target data, and the like.

Further, the examples of the data direction may include a direction derived from a series of values in the trajectory data or the like, a direction derived from vertex information or plane information of a three-dimensional solid shape, and the like.

In addition thereto, the data direction is not limited to the data relating to a position, and the present invention can be applied as long as the data direction can be acquired while an attribute added to the data is quantified. For example, the examples of the data direction may include a direction of a hue gradient or a luminance gradient based on color information or luminance information. In this way, the data browse apparatus 100 can improve the visibility according to a change in the attribute by treating a change in various attributes when the data is browsed as the data direction.

Further, the point data, the line data, and the plane data for acquiring the data direction do not have to be displayed on the display unit 102. For example, it is only necessary to calculate the hue gradient or the luminance gradient based on the color information or the luminance information and to store these gradient directions into a storage unit such as the RAM 108 or the storage unit 109 as the data direction, and these gradient directions do not have to be displayed on the display unit 102.

In this case, it is only necessary to change the display style regarding the data having the predetermined degree of correlation or to change the display style of a region having a predetermined gradient direction. In other words, the data browse apparatus 100 may change the display style of the data having the predetermined degree of correlation itself or may change the display style of the data (the region or the like) relating to the data having the predetermined degree of correlation.

Further, an arbitrary direction in the space of the data is acquired as the instruction direction. The operation instruction is input by, for example, a scroll operation with an operation of pressing a button, an operation of dragging the mouse, or the like, a touch operation with a single finger or a plurality of fingers, and a movement of a monitoring device, such as the unmanned airplane. With these operation instructions, the instruction direction is acquired based on a rotation, an enlargement, a reduction, a deformation of a display window, a change in an area of the display window, a change in a viewpoint in a 3D display, a change value of the gyro sensor, and the like.

As the display control when the data is browsed, the display style is changed according to the degree of correlation between the data direction and the instruction direction. Examples of the change in the display style include a change in a format (e.g., a width, a shade, a brightness, a color tone, a transparency) regarding the data, an increase/reduction in a scroll speed, a stop of the scroll, and a change in a scroll direction.

In this case, the data browse apparatus 100 may improve the visibility of the target data by performing the control of changing the format regarding the data and other image data control (e.g., control of a viewpoint, an angle of view) at the same time. Performing such display control provides an effect of improving the visibility when the data is browsed. For example, if a flow of data that is the tracing target is displayed with a large number of pieces of other data passing through this flow when multidimensional data is browsed, the data browse apparatus 100 can improve the visibility of the target data by highlighting the data that is the tracing target.

Further, the present invention can be applied to a data browse apparatus that acquires the data direction of the data. For example, an exemplary embodiment of the present invention can be applied to allow the data browse apparatus for the spatial data such as the path to the destination point on the map, the trajectory data, and computer-aided design (CAD) data to change the display style regarding specific data as described above. Further, an exemplary embodiment of the present invention can be applied to a data browse apparatus for a line graph, a social map, a mind map, and the like to change the display style of a specific line graph, a specific node link, or the like.

Further, an exemplary embodiment of the present invention can be applied to allow a data browse apparatus for three-dimensional topographic data (polygon data) and the like to change the display style of specific plane data (e.g., an undulating surface). Further, an exemplary embodiment of the present invention can be applied to change the display style of movement data (the line data) of a monitoring target imaged by an unmanned airplane including an imaging unit mounted thereon. In this case, a movement direction of a viewpoint, such as pan and tilt of the imaging unit, may be acquired as the instruction direction.

Further, an exemplary embodiment of the present invention can be applied to change the display style of image data (the point data, the line data, and the plane data) such as a blood vessel imaged by a medical imaging apparatus for use in an endoscopic surgery or the like.

Other than those, an exemplary embodiment of the present invention is applied to change the display style of image data (the point data, the line data, and the plane data) of Augmented Reality (AR) using a wearable device, an HMD, a tablet device, and the like. For example, the exemplary embodiment of the present invention can be applied to guide an operator of the AR device to a specific destination point by changing the display style of a path to the destination point.

According to the data browse apparatus of the exemplary embodiments, it is possible to improve the visibility by changing the display style regarding the data having the high degree of correlation with the instruction direction among the pieces of data on the browse screen. As a result, even when there are a large number of pieces of browse data, the data browse apparatus allows the user to desirably browse the browse data while keeping the detail level thereof from reducing and maintaining the visibility at the same time.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-111787, filed Jun. 1, 2015, which is hereby incorporated by reference herein in its entirety.

What is claimed is:

1. A data browse apparatus comprising:
a data direction acquisition unit configured to acquire a direction indicated by data expressing a path as a data direction;
an instruction direction acquisition unit configured to acquire a direction in a space of the data as an instruction direction;
a relationship acquisition unit configured to acquire a relationship between the data direction and the instruction direction; and
a display control unit configured to perform display control so as to make a difference in display content among a plurality of pieces of the data based on the relationship.

2. The data browse apparatus according to claim 1, further comprising a display range movement unit configured to move a display range of a display unit along the instruction direction.

3. The data browse apparatus according to claim 2, wherein the display range movement unit changes at least one of a movement speed and a movement direction of the display range of the display unit according to the relationship.

4. The data browse apparatus according to claim 1, wherein the data direction acquisition unit acquires, from a storage unit configured to store at least one piece of data among point data, line data, and plane data, at least one of a direction indicated by the point data at a position of the point data, a line direction of the line data, and a normal direction of the plane data as the data direction.

5. The data browse apparatus according to claim 4, wherein the data direction acquisition unit acquires, as the data direction, at least one of a tangential direction of the line data, a direction of a line segment between arbitrary two points on the line data that are displayed on a display unit, a direction of a line segment between arbitrary two points on the line data including a point on the line data that is not displayed on the display unit, an average of directions of a plurality of the line segments, a direction of a line segment between two points corresponding to an arbitrary movement time period if the line data is a movement of the point data, a direction of a line segment between two points corresponding to an arbitrary movement distance if the line data is a movement of the point data, a direction of a line segment between two points on the line data that are located near a start point and an end point of the instruction direction, a direction of a line segment between a predetermined reference point and the point data, and a direction of a line segment between the point data of two points.

6. The data browse apparatus according to claim 1, wherein the relationship acquisition unit calculates a degree of correlation between the data direction and the instruction direction based on at least one of an angle between the data direction and the instruction direction, a distance between an acquisition position of the data and an acquisition position of the instruction direction, and an inner product of the data direction and the instruction direction.

7. The data browse apparatus according to claim 6, wherein the display control unit highlights the data having the degree of correlation that is a predetermined threshold value or higher, or a predetermined threshold value or lower, on a display unit.

8. The data browse apparatus according to claim 6, wherein the display control unit displays the data on a display unit in an order of the degree of correlation, starting from the data having a highest degree of correlation or the data having a lowest degree of correlation.

9. The data browse apparatus according to claim 6,
wherein the relationship acquisition unit calculates a statistical value of the degree of correlation of the data contained in a display range of a display unit, and
wherein the display control unit changes a display style regarding the data according to the statistical value of the degree of correlation.

10. The data browse apparatus according to claim 6, further comprising an instruction direction recording unit configured to record at least one of the acquisition position, a direction, and a length of the instruction direction acquired by the instruction direction acquisition unit per predetermined time period,
wherein the relationship acquisition unit calculates the degree of correlation between the instruction direction recorded per predetermined time period and the data direction.

11. The data browse apparatus according to claim 6, wherein the relationship acquisition unit weights the degree of correlation according to the acquisition position of at least one of the data and the instruction direction.

12. The data browse apparatus according to claim 6, further comprising a direction setting unit configured to set a direction from a display range of a display unit to an outside of the display range,
wherein the data direction acquisition unit acquires the data direction outside the display range of the display unit,
wherein the instruction direction acquisition unit acquires the direction set by the direction setting unit as the instruction direction, and
wherein the relationship acquisition unit calculates the degree of correlation between the data direction outside the display range of the display unit and the instruction direction.

13. The data browse apparatus according to claim 1, further comprising an imaging unit configured to acquire image data for causing a display unit to display the data,
wherein the instruction direction acquisition unit acquires the instruction direction based on a movement direction of the imaging unit.

14. The data browse apparatus according to claim 1, wherein the instruction direction acquisition unit acquires a change direction in the data due to at least one of a rotation, an enlargement, a reduction, and switching of a display on a display unit as the instruction direction.

15. The data browse apparatus according to claim 1, wherein the instruction direction acquisition unit acquires the instruction direction based on at least one of a touch, a multi-touch, a click, a drag, a rotation, an angle, an angular speed, and an orientation input from an input unit.

16. The data browse apparatus according to claim 1, wherein the instruction direction acquisition unit acquires the instruction direction based on a scroll input from an input unit.

17. The data browse apparatus according to claim 1, wherein the instruction direction acquisition unit acquires the instruction direction in a fixed display range without moving the display range according to the instruction direction.

18. A data browse method comprising:
acquiring a direction indicated by data expressing a path as a data direction;
acquiring a direction in a space of the data as an instruction direction;
acquiring a relationship between the data direction and the instruction direction; and
performing display control so as to make a difference in display content among a plurality of pieces of the data based on the relationship.

19. A non-transitory computer-readable storage medium storing therein a program for causing a computer to perform the method according to claim 18.
